(19) United States
(12) Patent Application Publication
(10) Pub. No.: US 2025/0048053 A1
(43) Pub. Date: Feb. 6, 2025

(54) HYBRID RENDERING

(71) Applicant: QUALCOMM Incorporated, San Diego, CA (US)

(72) Inventors: Andre SCHEVCIW, San Diego, CA (US); Graham Bradley DAVIS, Seattle, WA (US); Andrea Felice GENOVESE, Brooklyn, NY (US)

(21) Appl. No.: 18/364,638

(22) Filed: Aug. 3, 2023

(51) Int. Cl. H04S 7/00; H04S 3/00

(52) U.S. Cl. CPC H04S 7/303; H04S 3/008; H04S 2400/01; H04S 2400/11; H04S 2400/13; H04S 2420/11

(57) ABSTRACT

A device includes a memory configured to store first audio data and second audio data. The device also includes one or more processors coupled to the memory and configured to determine priorities of audio sources of an audio scene. The one or more processors are also configured to render, using an object renderer, the first audio data to generate a first audio signal. The first audio data represents a first audio source associated with a first priority. The one or more processors are further configured to render, using a first ambisonics renderer, the second audio data to generate a second audio signal. The second audio data represents a second audio source associated with a second priority.

### I. Field

The present disclosure is generally related to audio rendering.

### II. Description of Related Art

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

One application of such devices includes providing immersive audio to a user. As an example, a headphone device worn by a user can receive streaming audio data from a remote server for playback to the user. The audio data can be rendered into audio signals that can be played out to the user via speakers of the headphone device. In general, there is a tradeoff between spatial accuracy and complexity in audio rendering. For example, ambisonics-based rendering is an efficient method for generating sound fields, providing smooth sound field rotation, and representing many audio sources. In addition, an amount of data used to represent a sound field can be reduced by using lower-order ambisonics to provide more efficient storage and transmission to the user as compared to using a higher order ambisonics. However, using lower-order ambisonics can introduce spatial blurring, making it difficult for a user to precisely determine the position (e.g., location) of audio sources. On the other hand, object-based rendering (convolution with head-related transfer function (HRTF)) provides high spatial accuracy but is too complex when multiple audio sources are involved.

### III. Summary

According to one implementation of the present disclosure, a device includes a memory configured to store first audio data and second audio data. The device also includes one or more processors coupled to the memory and configured to determine priorities of audio sources of an audio scene. The one or more processors are also configured to render, using an object renderer, the first audio data to generate a first audio signal. The first audio data represents a first audio source associated with a first priority. The one or more processors are further configured to render, using a first ambisonics renderer, the second audio data to generate a second audio signal. The second audio data represents a second audio source associated with a second priority.

According to another implementation of the present disclosure, a method includes determining priorities of audio sources of an audio scene. The method also includes rendering, using an object renderer, first audio data to generate a first audio signal. The first audio data represents a first audio source associated with a first priority. The method further includes rendering, using an ambisonics renderer, second audio data to generate a second audio signal. The second audio data represents a second audio source associated with a second priority.

According to another implementation of the present disclosure, a non-transitory computer-readable medium stores instructions that, when executed by one or more processors, cause the one or more processors to determine priorities of audio sources of an audio scene. The instructions also cause the one or more processors to render, using an object renderer, first audio data to generate a first audio signal. The first audio data represents a first audio source associated with a first priority. The instructions further cause the one or more processors to render, using an ambisonics renderer, second audio data to generate a second audio signal. The second audio data represents a second audio source associated with a second priority.

According to another implementation of the present disclosure, an apparatus includes means for determining priorities of audio sources of an audio scene. The apparatus also includes means for rendering, using an object renderer, first audio data to generate a first audio signal. The first audio data represents a first audio source associated with a first priority. The apparatus further includes means for rendering, using an ambisonics renderer, second audio data to generate a second audio signal. The second audio data represents a second audio source associated with a second priority.

According to another implementation of the present disclosure, a device includes a memory configured to store first audio data and second audio data. The device also includes one or more processors coupled to the memory and configured to determine priorities of audio sources of an audio scene. A first priority is assigned to a first audio source based at least in part on a determination that the first audio source has a first source position within a first target region of a visual scene. A second priority is assigned to a second audio source based at least in part on a determination that the second audio source has a second source position within a second target region of the visual scene. The one or more processors are also configured to render, using a first renderer, the first audio data to generate a first audio signal. The first audio data represents the first audio source associated with the first priority. The first renderer is of a first renderer type. The one or more processors are further configured to render, using a second renderer, the second audio data to generate a second audio signal. The second audio data represents the second audio source associated with the second priority. The second renderer is of a second renderer type.

According to another implementation of the present disclosure, a method includes determining priorities of audio sources of an audio scene. A first priority is assigned to a first audio source based at least in part on determining that the first audio source has a first source position within a first target region of a visual scene. A second priority is assigned to a second audio source based at least in part on determining that the second audio source has a second source position within a second target region of the visual scene. The method also includes rendering, using a first renderer, first audio data to generate a first audio signal. The first audio data represents the first audio source associated with the first priority. The first renderer is of a first renderer type. The method further includes rendering, using a second renderer, second audio data to generate a second audio signal. The second audio data represents the second audio source associated with the second priority. The second renderer is of a second renderer type.

According to another implementation of the present disclosure, a non-transitory computer-readable medium stores instructions that, when executed by one or more processors, cause the one or more processors to determine priorities of audio sources of an audio scene. A first priority is assigned to a first audio source based at least in part on determining that the first audio source has a first source position within a first target region of a visual scene. A second priority is assigned to a second audio source based at least in part on determining that the second audio source has a second source position within a second target region of the visual scene. The instructions, when executed by the one or more processors, also cause the one or more processors to render, using a first renderer, first audio data to generate a first audio signal. The first audio data represents the first audio source associated with the first priority. The first renderer is of a first renderer type. The instructions, when executed by the one or more processors, further cause the one or more processors to render, using a second renderer, second audio data to generate a second audio signal. The second audio data represents the second audio source associated with the second priority. The second renderer is of a second renderer type.

According to another implementation of the present disclosure, an apparatus includes means for determining priorities of audio sources of an audio scene. A first priority is assigned to a first audio source based at least in part on determining that the first audio source has a first source position within a first target region of a visual scene. A second priority is assigned to a second audio source based at least in part on determining that the second audio source has a second source position within a second target region of the visual scene. The apparatus also includes means for rendering, using a first renderer, first audio data to generate a first audio signal. The first audio data represents the first audio source associated with the first priority. The first renderer is of a first renderer type. The apparatus further includes means for rendering, using a second renderer, second audio data to generate a second audio signal. The second audio data represents the second audio source associated with the second priority. The second renderer is of a second renderer type.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system that is operable to perform hybrid rendering, in accordance with some examples of the present disclosure.

FIG. 2A is a diagram of an illustrative aspect of operations associated with a priority assigner of the system of FIG. 1, in accordance with some examples of the present disclosure.

FIG. 2B is a diagram of another illustrative aspect of operations associated with a priority assigner of the system of FIG. 1, in accordance with some examples of the present disclosure.

FIG. 2C is a diagram of another illustrative aspect of operations associated with a priority assigner of the system of FIG. 1, in accordance with some examples of the present disclosure.

FIG. 3A is a diagram of an illustrative aspect of a priority-based hybrid renderer of the system of FIG. 1, in accordance with some examples of the present disclosure.

FIG. 3B is a diagram of another illustrative aspect of a priority-based hybrid renderer of the system of FIG. 1, in accordance with some examples of the present disclosure.

FIG. 4 is a diagram of an illustrative aspect of operation of components of the system of FIG. 1, in accordance with some examples of the present disclosure.

FIG. 5 illustrates an example of an integrated circuit operable to perform hybrid rendering, in accordance with some examples of the present disclosure.

FIG. 6 is a diagram of a mobile device operable to perform hybrid rendering, in accordance with some examples of the present disclosure.

FIG. 7 is a diagram of a headset operable to perform hybrid rendering, in accordance with some examples of the present disclosure.

FIG. 8 is a diagram of a wearable electronic device operable to perform hybrid rendering, in accordance with some examples of the present disclosure.

FIG. 9 is a diagram of a voice-controlled speaker system operable to perform hybrid rendering, in accordance with some examples of the present disclosure.

FIG. 10 is a diagram of a headset, such as a virtual reality, mixed reality, or augmented reality headset, operable to perform hybrid rendering, in accordance with some examples of the present disclosure.

FIG. 11 is a diagram of a first example of a vehicle operable to perform hybrid rendering, in accordance with some examples of the present disclosure.

FIG. 12 is a diagram of a second example of a vehicle operable to perform hybrid rendering, in accordance with some examples of the present disclosure.

FIG. 13 is a diagram of a particular implementation of a method of performing hybrid rendering that may be performed by the system of FIG. 1, in accordance with some examples of the present disclosure.

FIG. 14 is a diagram of another particular implementation of a method of performing hybrid rendering that may be performed by the device of FIG. 1, in accordance with some examples of the present disclosure.

FIG. 15 is a block diagram of a particular illustrative example of a device that is operable to perform hybrid rendering, in accordance with some examples of the present disclosure.

### V. DETAILED DESCRIPTION

In general, there is a tradeoff between spatial accuracy and complexity in audio rendering. For example, scene-based audio rendering can use fewer resources, whereas object-based rendering can have higher spatial accuracy. To illustrate, ambisonics-based rendering is an efficient method for generating sound fields, providing smooth sound field rotation and representing many audio sources. In addition, an amount of data used to represent a sound field can be reduced by using lower-order ambisonics to provide more efficient storage and transmission to the user as compared to using a higher order ambisonics. However, using lower-order ambisonics can introduce spatial blurring, making it difficult for a user to precisely determine the position of audio sources. On the other hand, object-based rendering (convolution with head-related transfer function (HRTF)) provides high spatial accuracy but is too complex when multiple audio sources are involved.

Systems and methods of performing hybrid rendering are disclosed. A hybrid renderer assigns priorities to audio sources based on audio data from the audio sources, image data associated with the audio data, or both. In a first example, a first audio source that is in a first target region of an audio scene (e.g., in front of a user) is assigned a first priority, and a second audio source that is in a second target region of the audio scene (e.g., behind the user) is assigned a second priority that is lower than the first priority. In a second example, a first audio source that is in a first target region of a visual scene (e.g., a central region) is assigned a first priority, and a second audio source that is in a second target region of the visual scene (e.g., a peripheral region) is assigned a second priority that is lower than the first priority.

The hybrid renderer includes a plurality of renderers associated with the priorities. For example, the hybrid renderer includes a first renderer associated with the first priority, a second renderer associated with the second priority, and so on. The hybrid renderer uses the renderers to render sets of audio data to generate audio signals. For example, the hybrid renderer uses the first renderer to render audio data of audio sources that are assigned the first priority to generate a first audio signal. The hybrid renderer uses the second renderer to render audio data of audio sources that are assigned the second priority to generate a second audio signal. A stereo mixer mixes the audio signals to generate an output audio signal. For example, the stereo mixer mixes the first audio signal, the second audio signal, one or more additional audio signals generated by one or more additional renderers, or a combination thereof, to generate the output audio signal.

In some examples, the first renderer provides higher spatial accuracy, while the second renderer has less complexity and uses fewer resources (e.g., time and computing cycles). Audio data corresponding to higher priority audio sources is rendered using the first renderer to generate audio signals that have higher spatial accuracy, whereas audio data corresponding to lower priority audio sources is rendered using the second renderer to conserve resources. In some aspects, the first renderer (e.g., an object-based renderer) is used for audio sources in target regions where humans are expected to have higher angular discrimination, and the second renderer (e.g., an ambisonics renderer) is used for audio sources in remaining regions. Using the hybrid renderer thus provides the technical benefit of providing higher spatial accuracy for audio sources that are in regions where spatial accuracy is likely to be more noticeable to a user and conserving resources for audio sources that are in other regions where a lower spatial accuracy may be less noticeable to the user.

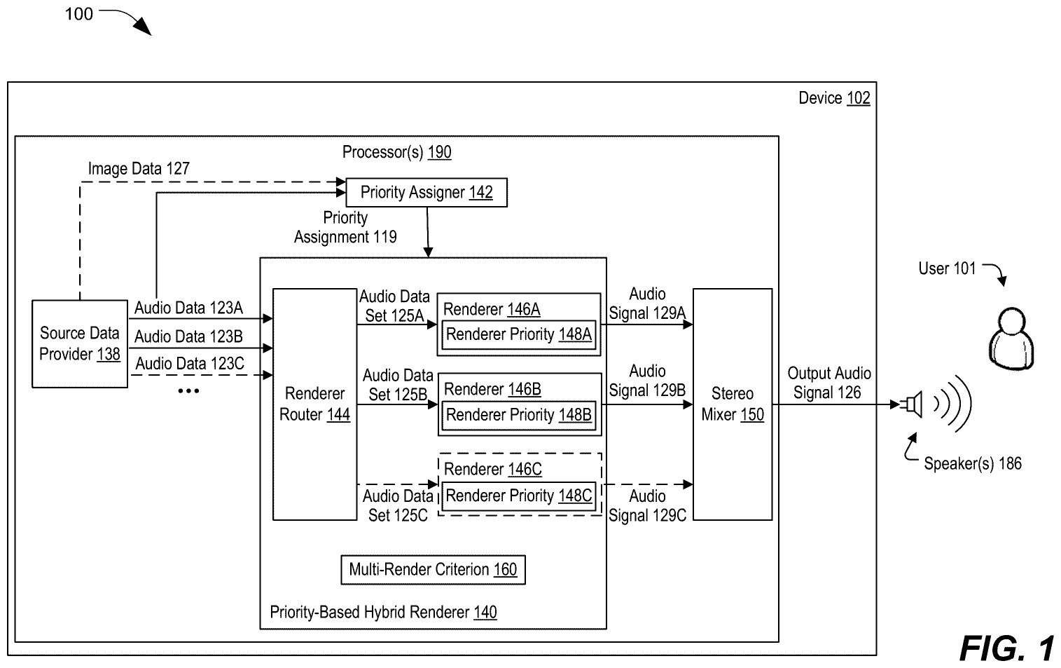

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple audio signals are illustrated and associated with reference numbers 129A, 129B, and 129C. When referring to a particular one of these audio signals, such as an audio signal 129A, the distinguishing letter “A” is used. However, when referring to any arbitrary one of these audio signals or to these audio signals as a group, the reference number 129 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

In general, techniques are described for coding of three dimensional (3D) sound data, such as ambisonics audio data. Ambisonics audio data may include different orders of ambisonic coefficients, e.g., first order or second order and more (which may be referred to as higher-order ambisonics (HOA) coefficients corresponding to a spherical harmonic basis function having an order greater than one). Ambisonics audio data may also include mixed order ambisonics (MOA). Thus, ambisonics audio data may include at least one ambisonic coefficient corresponding to a harmonic basis function.

The evolution of surround sound has made available many audio output formats for entertainment. Examples of such consumer surround sound formats are mostly ‘channel’ based in that they implicitly specify feeds to loudspeakers in certain geometrical coordinates. The consumer surround sound formats include the popular 5.1 format (which includes the following six channels: front left (FL), front right (FR), center or front center, back left or surround left, back right or surround right, and low frequency effects (LFE)), the growing 7.1 format, and various formats that include height speakers such as the 7.1.4 format and the 22.2 format (e.g., for use with the Ultra High Definition Television standard). Non-consumer formats can span any number of speakers (e.g., in symmetric and non-symmetric geometries) often termed ‘surround arrays.’ One example of such a sound array includes 32 loudspeakers positioned at coordinates on the corners of a truncated icosahedron.

The input to a future Moving Picture Experts Group (MPEG) encoder is optionally one of three possible formats: (i) traditional channel-based audio (as discussed above), which is meant to be played through loudspeakers at pre-specified positions; (ii) object-based audio, which involves discrete pulse-code-modulation (PCM) data for single audio objects with associated metadata containing their position coordinates (amongst other information); or (iii) scene-based audio, which involves representing the sound field using coefficients of spherical harmonic basis functions (also called “spherical harmonic coefficients” or SHC, “Higher-order Ambisonics” or HOA, and “HOA coefficients”). Scene-based audio can be represented using various techniques, such as ambisonics, multi-channel ambisonic sound augmentation (MASA), wave field synthesis (WFS), binaural rendering, distance attenuation and doppler effect simulation, other techniques, or a combination thereof. An MPEG encoder (e.g., an MPEG-H 3D Audio encoder) that can compress audio data while preserving the spatial characteristics of sound may be described in more detail in a document entitled “Call for Proposals for 3D Audio,” by the International Organization for Standardization/International Electrotechnical Commission (ISO)/(IEC) JTC1/SC29/WG11/N13411, released January 2013 in Geneva, Switzerland, and available at http://mpeg.chiariglione.org/sites/default/files/files/standards/parts/docs/wl3411.zip.

There are various ‘surround-sound’ channel-based formats currently available. The formats range, for example, from the 5.1 home theatre system (which has been the most successful in terms of making inroads into living rooms beyond stereo) to the 22.2 system developed by NHK (Nippon Hoso Kyokai or Japan Broadcasting Corporation). Content creators (e.g., Hollywood studios) would like to produce a soundtrack for a movie once, and not spend effort to remix it for each speaker configuration. Recently, Standards Developing Organizations have been considering ways in which to provide an encoding into a standardized bitstream and a subsequent decoding that is adaptable and agnostic to the speaker geometry (and number) and acoustic conditions at the location of the playback (involving a renderer).

To provide such flexibility for content creators, a hierarchical set of elements may be used to represent a sound field. The hierarchical set of elements may refer to a set of elements in which the elements are ordered such that a basic set of lower-ordered elements provides a full representation of the modeled sound field. As the set is extended to include higher-order elements, the representation becomes more detailed, increasing resolution.

One example of a hierarchical set of elements is a set of spherical harmonic coefficients (SHC). The following expression demonstrates a description or representation of a sound field using SHC:

$${p}_{i} ( t , {r}_{r} , {θ}_{r} , {φ}_{r} ) = {\sum }_{ω = 0}^{∞} [ 4 π {\sum }_{n = 0}^{∞} {j}_{n} ( k {r}_{r} ) {\sum }_{m = - n}^{n} {A}_{n}^{m} ( k ) {Y}_{n}^{m} ( {θ}_{r} , {φ}_{r} ) ] {e}^{j ω t}$$

The expression shows that the pressure pᵢ at any point {rᵣ, θᵣ, φᵣ} of the sound field, at time t, can be represented uniquely by the SHC, Aₙ^{m}(k). Here, k=ω/c is the speed of sound (˜343 m/s), {rᵣ, θᵣ, φᵣ} is a point of reference (or observation point), jₙ(·) is the spherical Bessel function of order n, and Yₙ^{m}(θᵣ, φᵣ) are the spherical harmonic basis functions of order n and suborder m. It can be recognized that the term in square brackets is a frequency-domain representation of the signal (i.e., S(ω, rᵣ, θᵣ, φᵣ)) which can be approximated by various time-frequency transformations, such as the discrete Fourier transform (DFT), the discrete cosine transform (DCT), or a wavelet transform. Other examples of hierarchical sets include sets of wavelet transform coefficients and other sets of coefficients of multiresolution basis functions.

A number of spherical harmonic basis functions for a particular order may be determined as: #basis functions=(n+1)\hat{ }2. For example, a tenth order (n=10) would correspond to 121 spherical harmonic basis functions (e.g., (10+1)\hat{ }2).

The SHC Aₙ^{m}(k) can either be physically acquired (e.g., recorded) by various microphone array configurations or, alternatively, they can be derived from channel-based or object-based descriptions of the sound field. The SHC represent scene-based audio, where the SHC may be input to an audio encoder to obtain encoded SHC that may promote more efficient transmission or storage. For example, a fourth-order representation involving (4+1)² (25, and hence fourth order) coefficients may be used.

As noted above, the SHC may be derived from a microphone recording using a microphone array. Various examples of how SHC may be derived from microphone arrays are described in Poletti, M., “Three-Dimensional Surround Sound Systems Based on Spherical Harmonics,” J. Audio Eng. Soc., Vol. 53, No. 11, 2005 November, pp. 1004-1025.

To illustrate how the SHCs may be derived from an object-based description, consider the following equation. The coefficients Aₙ^{m}(k) for the sound field corresponding to an individual audio object may be expressed as:

$${A}_{n}^{m} ( k ) = g ( ω ) ( - 4 π ik ) {h}_{n}^{( 2 )} ( k {r}_{s} ) {Y}_{n}^{{m}^{⋆}} ( {θ}_{s} , {φ}_{s} ) ,$$

where i is \sqrt{−1}, hₙ⁽²⁾(·) is the spherical Hankel function (of the second kind) of order n, and {rₛ, θₛ, φₛ} is the position of the object. Knowing the object source energy g(ω) as a function of frequency (e.g., using time-frequency analysis techniques, such as performing a fast Fourier transform on the PCM stream) enables conversion of each PCM object and the corresponding position into the SHC Aₙ^{m}(k). Further, it can be shown (since the above is a linear and orthogonal decomposition) that the Aₙ^{m}(k) coefficients for each object are additive. In this manner, a multitude of PCM objects can be represented by the Aₙ^{m}(k) coefficients (e.g., as a sum of the coefficient vectors for the individual objects). Essentially, the coefficients contain information about the sound field (the pressure as a function of 3D coordinates), and the above represents the transformation from individual objects to a representation of the overall sound field, in the vicinity of the observation point {rᵣ, θᵣ, φᵣ}.

Referring to FIG. 1, a particular illustrative aspect of a system configured to perform hybrid rendering is disclosed and generally designated 100. The system 100 includes a device 102 that is coupled to one or more speakers 186.

The device 102 includes one or more processors 190 that include a priority-based hybrid renderer 140 operable to perform hybrid rendering. The priority-based hybrid renderer 140 is coupled to a source data provider 138, a priority assigner 142, and a mixer, such as a stereo mixer 150. The stereo mixer 150 is configured to be coupled to the one or more speakers 186.

The source data provider 138 is configured to provide audio data 123 associated with a plurality of audio sources of an audio scene to the priority-based hybrid renderer 140 and to the priority assigner 142. In an example, audio data 123A represents audio from a first audio source of the audio scene, audio data 123B represents audio from a second audio source of the audio scene, audio data 123C represents audio from a third audio source of the audio scene, and so on. In a particular implementation, the source data provider 138 is configured to perform audio source extraction on one or more input audio signals to generate the audio data 123. In a particular implementation, the source data provider 138 is configured to retrieve the audio data 123 from a memory, a storage device, a network device, or a combination thereof.

The priority assigner 142 is configured to generate a priority assignment 119 indicating priorities assigned to the plurality of audio sources of the audio data 123. In some examples, the priority assigner 142 is configured to assign an audio source priority to an audio source based at least in part on a source position of the audio source in the audio scene, a source position of the audio source in a visual scene, or both.

The priority-based hybrid renderer 140 includes a renderer router 144 coupled to renderers 146. Each of the renderers 146 is associated with a respective priority. For example, a renderer 146 is associated with (e.g., assigned) a flag (or other type of data structure) indicating a renderer priority 148 of the renderer 146. To illustrate, a renderer 146A is associated with a renderer priority 148A, a renderer 146B is associated with a renderer priority 148B that is a lower priority than the renderer priority 148A, a renderer 146C is associated with a renderer priority 148C that is a lower priority than the renderer priority 148B, and so on.

In a particular aspect, a higher priority renderer 146 is associated with higher spatial accuracy. For example, the renderer 146A is associated with a higher spatial accuracy than the renderer 146B, and the renderer 146B is associated with a higher spatial accuracy than the renderer 146C. In a particular aspect, a lower priority renderer 146 uses fewer processing resources. For example, the renderer 146C uses fewer processing resources than the renderer 146B, and the renderer 146B uses fewer processing resources than the renderer 146A.

The renderer router 144 is configured to route the audio data 123 to the renderers 146 with renderer priorities that match the audio source priorities assigned to the audio sources. For example, the renderer router 144 is configured to, in response to determining that the first audio source of the audio data 123A is assigned a first audio source priority that matches the renderer priority 148A of the renderer 146A, select the renderer 146A to render the audio data 123A and provide the audio data 123A to the renderer 146A. Each of the renderers 146 is configured to render audio data received from the renderer router 144 to generate an audio signal 129. The stereo mixer 150 is configured to mix the audio signals 129 received from the renderers 146 to generate an output audio signal 126. According to some implementations, the renderers 146 include binaural renderers. In these implementations, the audio signals 129 and the output audio signal 126 correspond to binaural audio signals.

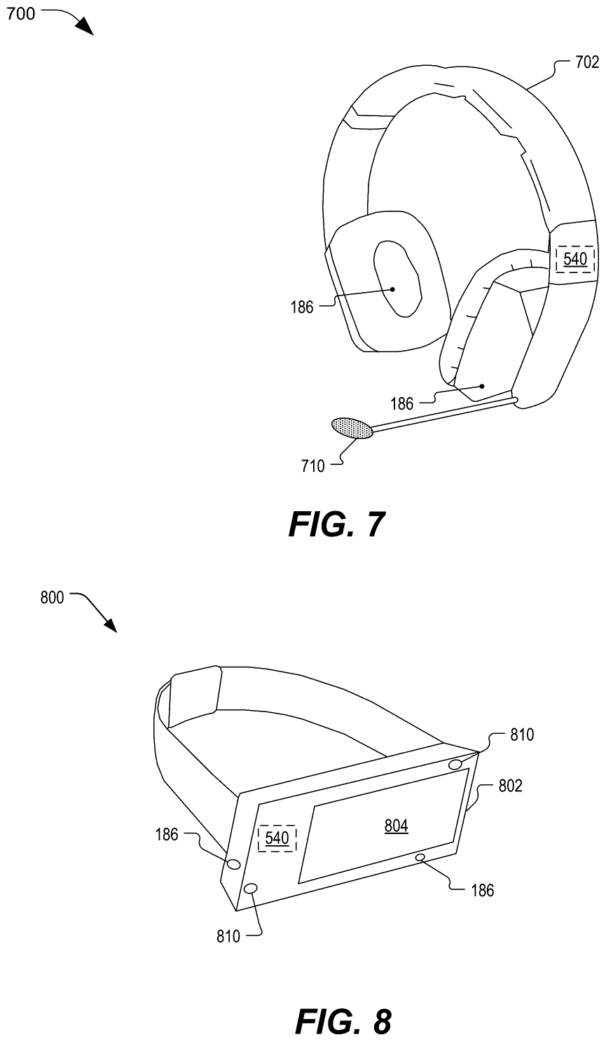

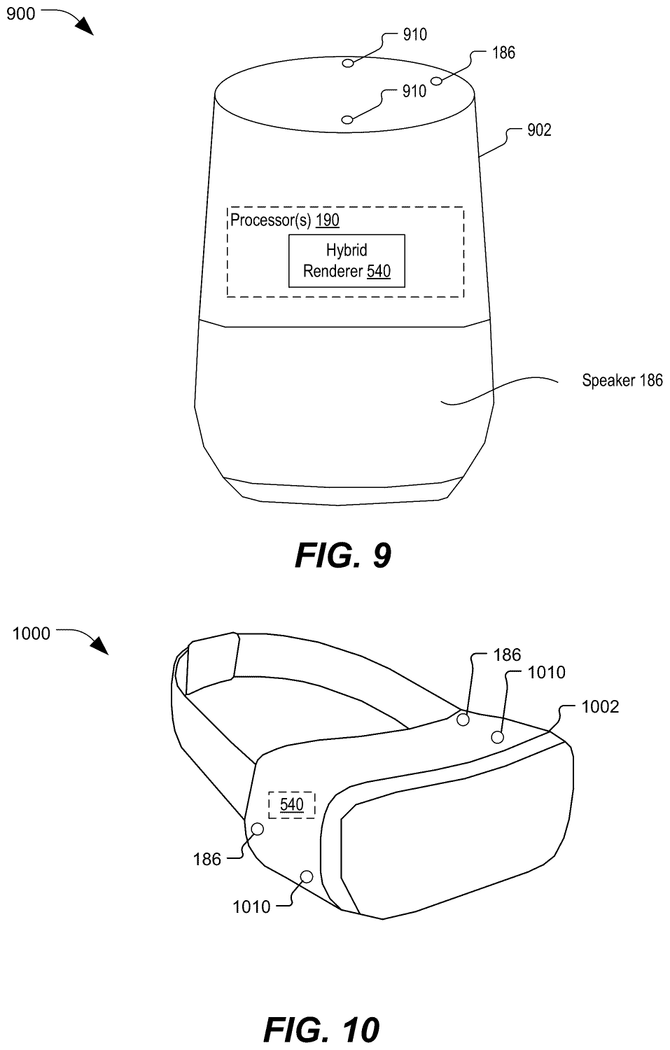

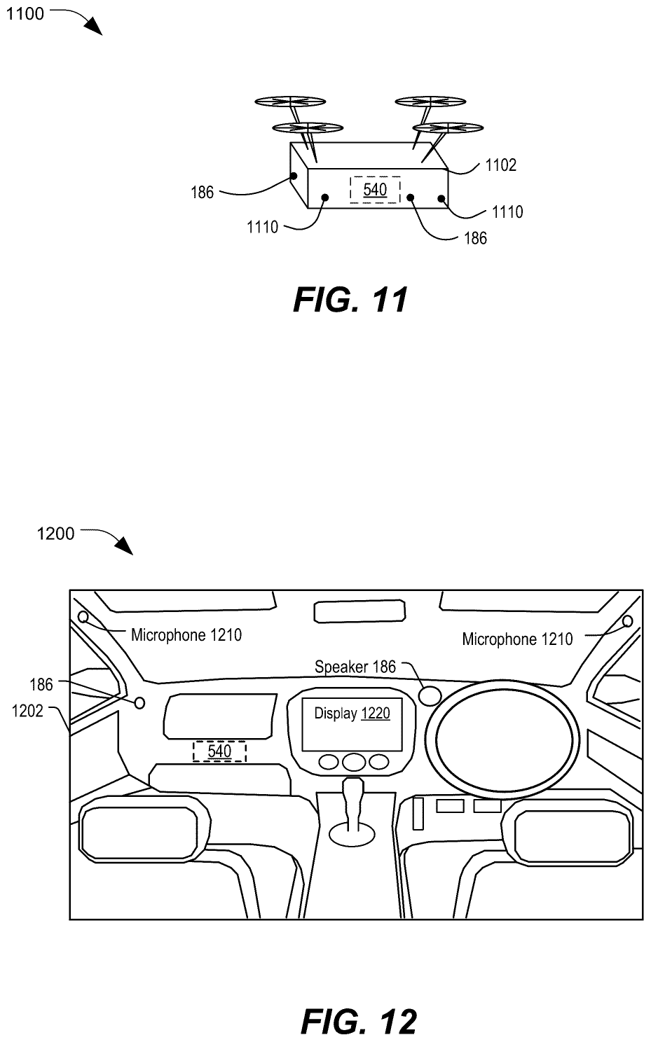

In some implementations, the device 102 corresponds to or is included in one of various types of devices. In an illustrative example, the one or more processors 190 are integrated in a headset device that includes the one or more speakers 186, such as described further with reference to FIG. 7. In other examples, the one or more processors 190 are integrated in at least one of a mobile phone or a tablet computer device, as described with reference to FIG. 6, a wearable electronic device, as described with reference to FIG. 8, a voice-controlled speaker system, as described with reference to FIG. 9, or a virtual reality, mixed reality, or augmented reality headset, as described with reference to FIG. 10. In another illustrative example, the one or more processors 190 are integrated into a vehicle that also includes the one or more speakers 186, such as described further with reference to FIG. 11 and FIG. 12.

During operation, the source data provider 138 provides audio data 123 to the priority assigner 142 and to the priority-based hybrid renderer 140. The audio data 123 is representative of an audio scene. According to some implementations, the source data provider 138 also provides image data 127, that is associated with the audio data 123A, to the priority assigner 142.

In a particular aspect, the image data 127 is representative of a visual scene corresponding to the audio scene. In some implementations, the audio scene corresponds to a virtual audio scene, a physical audio scene, or both. In some implementations, the visual scene corresponds to a virtual visual scene, a physical visual scene, or both. In an example, the audio sources include one or more live audio sources, one or more virtual audio sources, or a combination thereof. In a particular aspect, the audio scene is relative to a listener (e.g., a user 101). In a particular aspect, the video scene is relative to a viewer (e.g., the user 101).

In an illustrative example, the source data provider 138 receives one or more input audio signals from one or more microphones and concurrently receives the image data 127 from an image sensor (e.g., a still camera, a video camera, or both). The source data provider 138 performs audio source extraction on the one or more input audio signals to generate the audio data 123. For example, the source data provider 138 performs audio source extraction on audio data corresponding to the one or more input audio signals to generate the audio data 123A representative of audio of a first audio source, the audio data 123B representative of audio of a second audio source, the audio data 123C representative of audio of a third audio source, one or more additional sets of audio data corresponding to one or more respective additional audio sources, or a combination thereof.

In an illustrative example, the source data provider 138 decodes encoded audio data to generate the one or more input audio signals, the audio data 123, or a combination thereof. In an illustrative example, the source data provider 138 retrieves the one or more input audio signals, the audio data 123, or a combination thereof, from a memory, a storage device, a network device, another component of the device 102 (e.g., a game engine), or a combination thereof.

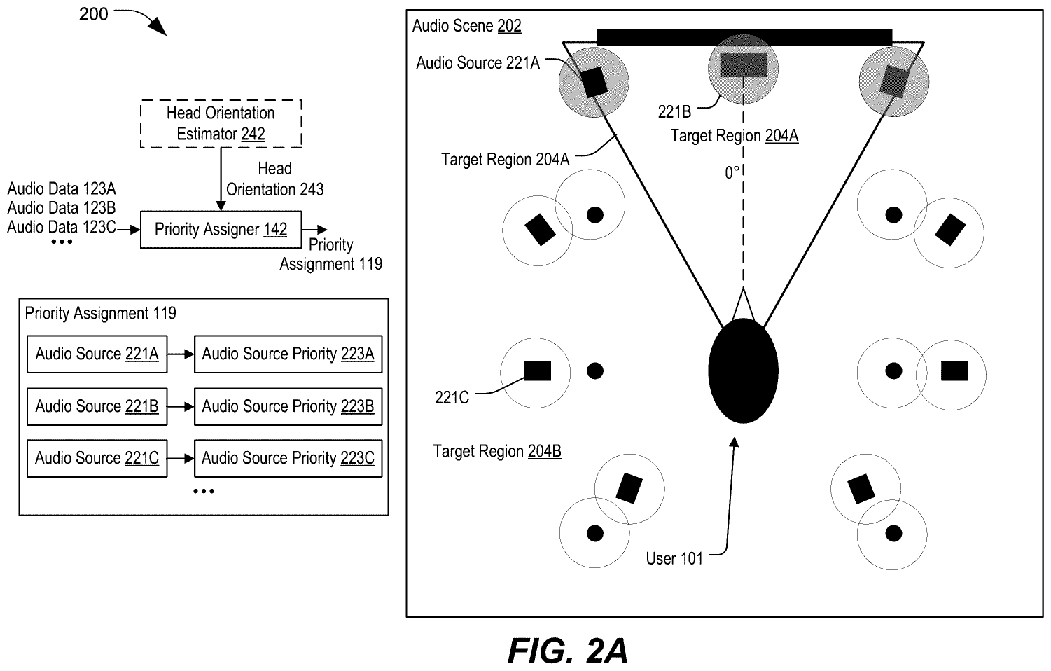

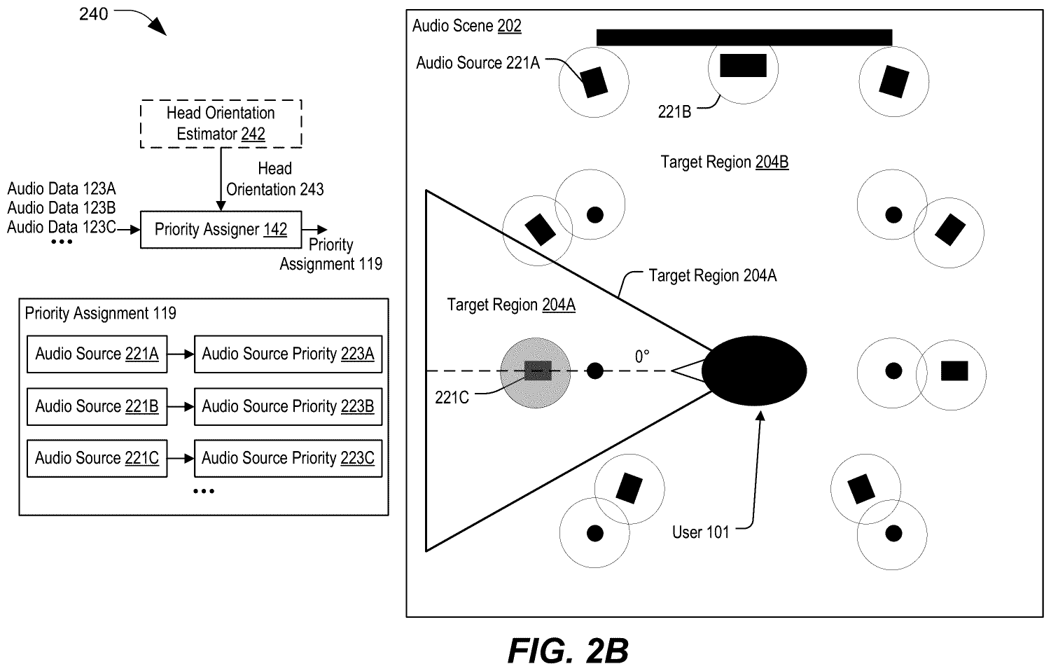

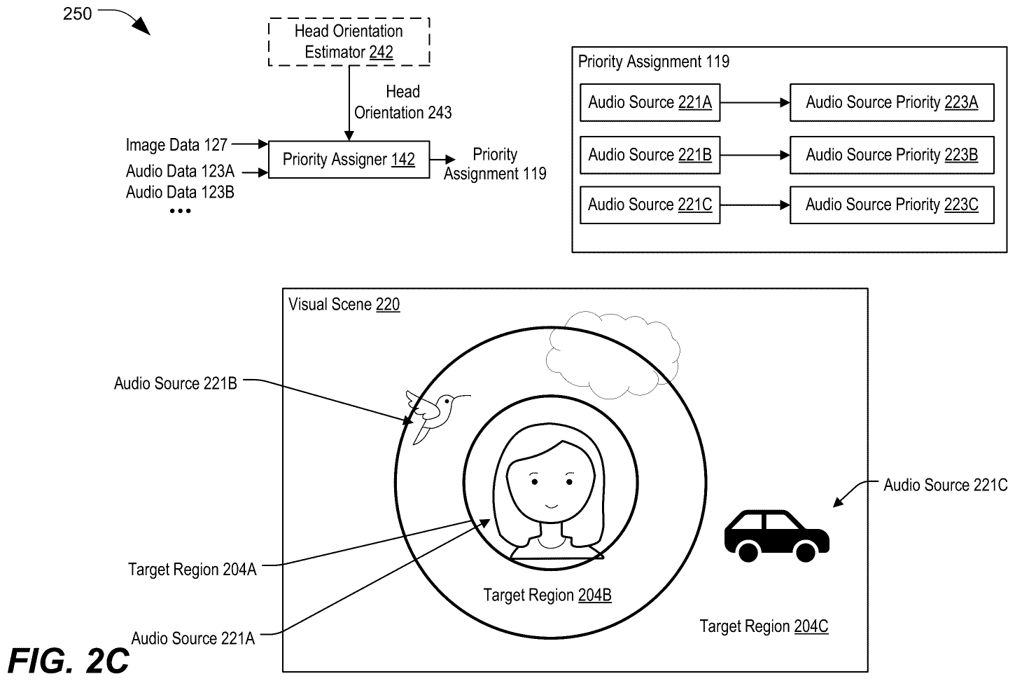

In some implementations, the audio data 123 also indicates audio source positions of the audio sources detected in the audio scene. For example, the audio data 123A indicates a first audio source position of the first audio source detected in the audio scene. As another example, the audio data 123B indicate a second audio source position of the second audio source detected in the audio scene. In some implementations, the priority assigner 142 uses various source detection techniques to determine, based on the audio data 123, the image data 127, or both, source positions of the audio sources in the audio scene, source positions of the audio sources in the visual scene, or both, as further described with reference to FIGS. 2A-2C.

The priority assigner 142 assigns audio source priorities based on the source positions in the audio scene, the source positions in the visual scene, or both, as further described with reference to FIGS. 2A-2C. In an illustrative example, the priority assigner 142 defines a cone of high auditory resolution around a gaze direction of the user 101, as further described with reference to FIGS. 2A-2C. The priority assigner 142, for a given gaze direction (e.g., corresponding to a particular head pose of the user 101), designates audio sources with source positions within the cone of high auditory resolution as having higher priority, and designates audio sources with source positions outside the cone as having lower priority.

According to some implementations, the priority assigner 142 generates (e.g., updates) the priority assignment 119 based on user input from the user 101. For example, the priority assigner 142 generates a graphical user interface (GUI) indicating the audio source priorities and provides the GUI to a display device. The priority assigner 142, responsive to providing the GUI to the display device, receives user input indicating updates to the audio source priorities and updates the priority assignment 119 based on the updates indicated in the user input. The priority assigner 142 provides the priority assignment 119 to the priority-based hybrid renderer 140.

The renderer router 144, based on audio source priorities indicated in the priority assignment 119, routes the audio data 123 to the renderers 146. Audio data 123 of higher priority audio sources is routed to a higher priority renderer (e.g., a higher spatial accuracy renderer), and audio data 123 of lower priority audio sources is routed to a lower priority renderer (e.g., a lower resource usage renderer). To illustrate, the renderer router 144 groups sets of audio data 123 having audio source priorities that match the renderer priority 148A in an audio data set 125A and provides the audio data set 125A to the renderer 146A. For example, the renderer router 144, in response to determining that the priority assignment 119 indicates that the first audio source has a first audio source priority that matches the renderer priority 148A, adds the audio data 123A of the first audio source to the audio data set 125A. In a particular aspect, the first audio source priority matches the renderer priority 148A if the first audio source priority is greater than or equal to the renderer priority 148A. As another example, the renderer router 144, in response to determining that the priority assignment 119 indicates that the second audio source has a second audio source priority that matches the renderer priority 148B, adds the audio data 123B of the second audio source to the audio data set 125B. In a particular aspect, the second audio source priority matches the renderer priority 148B if the second audio source priority is less than the renderer priority 148A and greater than or equal to the renderer priority 148B.

More than one set of audio data 123 can be included in the same audio data set 125. For example, the renderer router 144, in response to determining that the priority assignment 119 indicates that the third audio source has a third audio source priority that matches the renderer priority 148B, adds the audio data 123C to the audio data set 125B. Similarly, in some examples, the renderer router 144 generates one or more additional audio data sets. To illustrate, the renderer router 144 generates an audio data set 125C of one or more sets of audio data 123 of audio sources with audio source priorities matching the renderer priority 148C. The renderer router 144 provides the audio data set 125A to the renderer 146A, the audio data set 125B to the renderer 146B, the audio data set 125C to the renderer 146C, one or more additional audio data sets 125 to corresponding renderers 146, or a combination thereof. In some aspects, a count of audio sources is greater than or equal to a count of audio data sets 125 generated by the renderer router 144. In some aspects, the count of audio sources is greater than or equal to a count of audio signals 129 generated by the renderers 146.

A renderer 146 renders a corresponding audio data set 125 to generate an audio signal 129. For example, the renderer 146A renders the audio data set 125A to generate an audio signal 129A, the renderer 146B renders the audio data set 125B to generate an audio signal 129B, the renderer 146C renders the audio data set 125C to generate an audio signal 129C, or a combination thereof. In some aspects, the renderer 146A corresponds to a higher spatial accuracy renderer as compared to the renderer 146B, and the renderer 146B corresponds to a lower resource usage renderer as compared to the renderer 146A. In a particular example, the renderer 146A corresponds to an object-based renderer, and the renderer 146B corresponds to an ambisonics renderer. In another example, the renderer 146A corresponds to a higher order ambisonics renderer and the renderer 146B corresponds to a lower order ambisonics renderer.

The stereo mixer 150 mixes the audio signals 129 from the renderers 146 to generate an output audio signal 126. For example, the stereo mixer 150 mixes the audio signal 129A, the audio signal 129B, the audio signal 129C, one or more additional audio signals 129, or a combination thereof to generate the output audio signal 126.

In a particular implementation, the stereo mixer 150 applies gains to the audio signals 129 based on the audio source priorities to generated gain adjusted signals, and mixes the gain adjusted signals to generate the output audio signal 126. In an example, the stereo mixer 150 determines a first gain based on the renderer priority 148A. In some implementations, the stereo mixer 150 determines the first gain based at least in part on an audio source priority of an audio source of audio data 123 that is included in the audio data set 125A. As another example, the stereo mixer 150 determines a second gain based on the renderer priority 148B. In some implementations, the stereo mixer 150 determines the second gain based on an audio source priority of an audio source of audio data 123 that is included in the audio data set 125B. In a particular aspect, the first gain is higher than the second gain because the renderer priority 148A is higher than the renderer priority 148B, the first audio source priority is higher than the second audio source priority, or both.

The stereo mixer 150 applies the first gain to the audio signal 129A to generate a first gain adjusted signal, the second gain to the audio signal 129B to generate a second gain adjusted signal, a third gain to the audio signal 129C to generate a third gain adjusted signal, or a combination thereof. The stereo mixer 150 mixes the first gain adjusted signal, the second gain adjusted signal, the third gain adjusted signal, one or more additional gain adjusted signals, or a combination thereof, to generate the output audio signal 126. In a particular implementation, the stereo mixer 150 provides the output audio signal 126 to the one or more speakers 186 for playback to the user 101.

According to some implementations, the hybrid rendering using multiple renderers is selectively enabled based on determining that a multi-render criterion 160 is satisfied. The priority-based hybrid renderer 140 is configured to determine that the multi-render criterion 160 is satisfied based on determining that a count of the audio sources (e.g., a count of the sets of the audio data 123) is greater than a count threshold, that an available memory of the device 102 is less than a memory threshold, that a remaining battery charge of the device 102 is less than a battery threshold, that a user setting indicates that multiple renderers are to be used, that the audio sources have audio source priorities (e.g., as indicated by the priority assignment 119) that match at least two of the renderer priorities 148, or a combination thereof. In some implementations, the priority-based hybrid renderer 140 determines that the multi-render criterion 160 is satisfied in response to determining that at least one audio source within a target region is emitting sound. For example, the priority-based hybrid renderer 140, in response to determining that none of the target regions include any audio source emitting a sound, uses a single renderer to generate the output audio signal 126. In some implementations, the single renderer includes a lower priority renderer (e.g., the renderer 146C) since no audio source is detected in higher priority target regions.

The priority-based hybrid renderer 140, in response to determining that the multi-render criterion 160 is satisfied, routes the audio data 123 to the renderers 146 based on the audio source priorities indicated by the priority assignment 119. Alternatively, the priority-based hybrid renderer 140, in response to determining that the multi-render criterion 160 is not satisfied, uses a single renderer (e.g., the renderer 146A) to render the audio data 123 to generate the output audio signal 126 (e.g., the audio signal 129A). In some implementations, the priority-based hybrid renderer 140, in response to determining that the multi-render criterion 160 is no longer satisfied, transitions from routing the audio data 123 to the multiple renderers (e.g., the renderers 146) to using a single renderer to generate the output audio signal 126. Alternatively, the priority-based hybrid renderer 140, in response to determining that the multi-render criterion 160 is satisfied, transitions from using a single renderer to generate the output audio signal 126 to routing the audio data 123 to the multiple renderers (e.g., the renderers 146).

A technical advantage of the system 100 includes balancing spatial accuracy with conserving resources in audio rendering. Audio data corresponding to audio sources in regions that a user is expected to have higher auditory discrimination are rendered to have higher spatial accuracy, whereas fewer processing resources are used to render audio data corresponding to audio sources in regions where the user is expected to perceive little or no degradation associated with lower spatial accuracy.

Although the one or more speakers 186 are illustrated as being coupled to the device 102, in other implementations at least one of the one or more speakers 186 may be integrated in the device 102. Although the source data provider 138, the priority assigner 142, and the stereo mixer 150 are illustrated as included in the device 102 that includes the priority-based hybrid renderer 140, in other implementations one or more of the source data provider 138, the priority assigner 142, or the stereo mixer 150 can be external to the device 102.

Dashed lines are used to illustrate optional components. For example, a dashed line is used in FIG. 1 to illustrate the priority assigner 142 receiving the image data 127. In some implementations, the priority assigner 142 generates the priority assignment 119 based at least in part on the image data 127. In other implementations, the priority assigner 142 generates the priority assignment 119 independently of the image data 127. As another example, the renderer 146C is illustrated using a dashed line in FIG. 1 to indicate that the renderer 146C is an optional component. In some implementations, the renderers 146 include three renderers, such as the renderer 146A, the renderer 146B, and the renderer 146C. In other implementations, the renderers 146 can include fewer than three renderers, such as the renderer 146A and the renderer 146B and not the renderer 146C. In yet other implementations, the renderers 146 can include more than three renderers.

A dashed line is used in FIG. 1 to illustrate the source data provider 138 generating the audio data 123C. In some implementations, the source data provider 138 generates audio data of three audio sources, e.g., the audio data 123A, the audio data 123B, and the audio data 123C. In other implementations, the source data provider 138 generates audio data of fewer than three audio sources, e.g., the audio data 123A and the audio data 123B. In yet other examples, the source data provider 138 generates audio data of more than three audio sources, the audio data 123A, the audio data 123B, the audio data 123C, and sets of audio data of one or more additional audio sources.

A dashed line is used in FIG. 1 to illustrate the renderer router 144 generating the audio data set 125C. In some implementations, the renderer router 144 generates three audio data sets, such as the audio data set 125A, the audio data set 125B, and the audio data set 125C, including audio data with audio source priorities that match renderer priorities of three renderers, such as the renderer 146A, the renderer 146B, and the renderer 146C. In other implementations, the renderer router 144 generates fewer than three audio sets, e.g., the audio data set 125A and the audio data set 125B. In yet other examples, the renderer router 144 generates audio data sets including audio data with audio source priorities that match more than three renderers.

A dashed line is used in FIG. 1 to illustrate the stereo mixer 150 receiving the audio signal 129C. In some implementations, the stereo mixer 150 receives three audio signals, such as the audio signal 129A, the audio signal 129B, and the audio signal 129C, from the priority-based hybrid renderer 140. In other implementations, the stereo mixer 150 receives fewer than three audio signals from the priority-based hybrid renderer 140, e.g., the audio signal 129A and the audio signal 129B. In yet other examples, the stereo mixer 150 receives more than three audio signals from the priority-based hybrid renderer 140. To illustrate, if the renderers 146 include the renderer 146C and the renderer 146C receives an audio data set 125C that includes audio data from at least one audio source, the stereo mixer 150 receives the audio signal 129C from the renderer 146C. Alternatively, if the renderers 146 do not include the renderer 146C or the renderer 146C does not receive the audio data set 125C including audio data from at least one audio source, the stereo mixer 150 generates the output audio signal 126 independently of receiving the audio signal 129C.

FIG. 2A is a diagram 200 of an illustrative aspect of operations associated with the priority assigner 142, in accordance with some examples of the present disclosure. In some implementations, the priority assigner 142 is coupled to a head orientation estimator 242. In some aspects, the one or more processors 190 of FIG. 1 include the head orientation estimator 242. The head orientation estimator 242 is illustrated using dashed lines to indicate that the head orientation estimator 242 is optional.

The head orientation estimator 242 is configured to estimate a head orientation 243 (e.g., a head pose) of the user 101. In a particular aspect, the head orientation estimator 242 estimates the head orientation 243 based on an orientation of a headset, relative positions of earphones, an image of the user 101, or a combination thereof.

The priority assigner 142 identifies a plurality of target regions 204 of an audio scene 202. In a particular aspect, the priority assigner 142 determines the target regions 204 based on a gaze direction of the user 101 and a source localization angle (e.g., a field of view). To illustrate, the priority assigner 142 identifies a target region 204A that is centered (e.g., 0 degrees) along the gaze direction of the user 101 and has a shape (e.g., a maximum width) that is based on the source localization angle. In some implementations, the priority assigner 142 estimates the gaze direction of the user 101 based on the head orientation 243.

According to some aspects, the source localization angle (e.g., −10 degrees to +10 degrees) is based on a configuration setting, default data, a user input, or a combination thereof. In a particular aspect, the source localization angle (e.g., the aperture of the cone of high auditory resolution) is based on a field of view of a camera, a field of view of an extended reality (XR) device, a characteristic (e.g., a beamwidth, a beam angle, or both) of a microphone beamformer, or a combination thereof. The priority assigner 142 designates a remaining portion of the audio scene 202 that is outside the target region 204A as a target region 204B. In a particular aspect, the target region 204A corresponds to a cone of high auditory resolution around the gaze direction of the user 101, and the target region 204B corresponds to lower auditory resolution.

Each of the target regions 204 is associated with a target region priority. For example, the target region 204A is assigned a first target region priority, and the target region 204B is assigned a second target region priority that is lower than the first target region priority. It should be understood that the priority assigner 142 identifying two target regions in the audio scene 202 is provided as an illustrative example, in other examples the priority assigner 142 can identify more than two target regions in the audio scene 202. Similarly, the target regions 204 associated with two target region priorities is provided as an illustrative example, and in other examples the target regions 204 can be associated with more than two target region priorities. To illustrate, the priority assigner 142 can also identify target regions 204C (not shown) on either side of the user 101, and these target regions can each have a third target region priority that is lower than the first target region priority of the target region 204A and that is higher than the second target region priority of audio sources behind the user 101 (e.g., in the target region 204B).

The audio data 123 is representative of audio from audio sources 221 in the audio scene 202. For example, the audio data 123A, the audio data 123B, and the audio data 123C are representative of audio from an audio source 221A, audio from an audio source 221B, and audio from an audio source 221C, respectively, in the audio scene 202. The audio sources 221 are shown as loudspeakers in FIG. 2A as an illustrative example, in other examples the audio sources 221 can include any type of audio source, such as a person, a loudspeaker, a vehicle, a machine, an alarm, an animal, a live audio source, a virtual audio source, or a combination thereof.

In some implementations, the audio data 123 indicates audio source positions of the audio sources 221 detected in the audio scene 202. For example, the audio data 123A indicates a first audio source position of the audio source 221A in the audio scene 202. In other implementations, the priority assigner 142 uses various source detection techniques to determine, based on the audio data 123, the audio source positions of the audio sources 221 in the audio scene 202. In an example, the audio source 221A, the audio source 221B, and the audio source 221C have a first audio source position, a second audio source position, and a third audio source position, respectively, in the audio scene 202.

In some examples, the priority assigner 142 updates (e.g., refines) the audio source positions based on the image data 127. As an illustrative example, the priority assigner 142 determines, based on the audio data 123A, that the audio source 221A associated with the audio data 123A is estimated to be within a range of source positions in the audio scene 202 (e.g., between −10 to 0 degrees in the front-left of the user 101). The priority assigner 142 determines, based on the image data 127, that the audio source 221A is estimated to be at a particular audio source position (e.g., −10 degrees in the front-left of the user 101) in the audio scene 202.

According to some implementations, the priority assigner 142 assigns audio source priorities 223 to the audio sources 221 based on the audio source positions in the audio scene 202. For example, the priority assigner 142, in response to determining that a first audio source position of the audio source 221A is within the target region 204A having the first target region priority, determines an audio source priority 223A based on the first target region priority and assigns the audio source priority 223A to the audio source 221A. As another example, the priority assigner 142, in response to determining that a second audio source position of the audio source 221B is within the target region 204A associated with the first target region priority, determines an audio source priority 223B based on the first target region priority and assigns the audio source priority 223B to the audio source 221B. As yet another example, the priority assigner 142, in response to determining that a third audio source position of the audio source 221C is within the target region 204B associated with the second target region priority, determines an audio source priority 223C based on the second target region priority and assigns the audio source priority 223C to the audio source 221C.

In an example, the target region 204A corresponds to a field of view of the user 101 and the field of view corresponds to a cone in a forward-looking direction from the head of the user 101. The priority assigner 142, based on determining that the first audio source position is within the field of view, determines the audio source priority 223A based on the first target region priority of the target region 204A. In a particular aspect, the head orientation estimator 242 estimates the head orientation 243. The priority assigner 142, based on the head orientation 243 and the first audio source position determines that the user 101 is facing the audio source 221A. The priority assigner 142, based on determining that the user 101 is facing the audio source 221A, determines that the first audio source position is within the target region 204A and determines the audio source priority 223A based on the first target region priority of the target region 204A.

In a particular aspect, the priority assigner 142 assigns a higher priority to audio sources that are in front of the user 101 than to audio sources that are behind the user 101 so that the audio sources in the front can be rendered with greater spatial accuracy. In some implementations, the priority assigner 142 determines the audio source priority 223A based on the target region priority of the target region 204A (that includes the first audio source position of the audio source 221A), a source identifier of the audio source 221A, a source type of the audio source 221A, a source output (e.g., emitting sound) of the audio source 221A, the source localization angle, the first audio source position, or a combination thereof.

In an example, an audio source 221 that is emitting a particular type of audio (e.g., speech) has higher priority than an audio source 221 that is emitting another type of audio (e.g., noise). In an example, an audio source 221 of a first source type (e.g., a baby monitor) has higher priority than an audio source 221 of a second source type (e.g., a music player). In an example, an audio source 221 having a particular identifier (e.g., a person identifier) has higher priority. In an example, an audio source 221 that has started emitting sound has higher priority than an audio source 221 that has stopped emitting sound.

According to some implementations, the priority assigner 142 determines an audio source priority 223 of an audio source 221 based on a weighted sum of priorities of various factors (e.g., the target region priority, a source identifier priority, a source type priority, a source output priority, one or more additional priorities, or a combination thereof) associated with the audio source 221. In a particular aspect, the weights used to determine the audio source priority 223 are based on user input, a configuration setting, default data, or a combination thereof. The priority assigner 142 generates the priority assignment 119 indicating the audio source priorities 223 assigned to the audio sources 221.

FIG. 2B is a diagram 240 of an illustrative aspect of operations associated with the priority assigner 142, in accordance with some examples of the present disclosure. In a particular aspect, the priority assigner 142 updates audio source priorities 223 based on detecting a change.

As an example, the priority assigner 142 updates the audio source priorities 223 based on detecting a change in a source position of an audio source 221, a change in the head orientation 243, a change in a gaze direction of the user 101, a change in a source localization angle, a change in the target regions 204, a change in a source output, a user input, a configuration setting, or a combination thereof. In a particular aspect, the priority assigner 142 estimates the change in the gaze direction of the user 101 based on detecting a head rotation (e.g., a change in the head orientation 243) of the user 101. In some aspects, the head rotation (e.g., a change in the head orientation 243) is detected based on rotation of a headset of the user 101.

In an illustrative example, the priority assigner 142 updates the target regions 204 in response to detecting a change in the gaze direction (e.g., a change in the head orientation 243), and updates the priority assignment 119 based on the updated target regions 204. To illustrate, in FIG. 2B, the user 101 turns to the left, causing the target region 204A to move to include the audio source 221C and causing the target region 204B to move to include the audio source 221A and the audio source 221B. As a result, the priority assigner 142 updates the priority assignment 119 to assign a higher priority (e.g., based on the first target region priority of the target region 204A) as the audio source priority 223C of the audio source 221C, and to assign a lower priority (e.g., based on the second target region priority of the target region 204B) as the audio source priority 223A of the audio source 221A and the audio source priority 223B of the audio source 221B. The audio source priority 223 of an audio source 221 can thus be based on a source position of the audio source 221 relative to a head orientation (e.g., field of view) of the user 101. The priority assigner 142 provides the priority assignment 119 to the renderer router 144.

According to some implementations, the priority assigner 142 determines a change in the source position of an audio source 221 based on detecting a movement of the audio source 221, a movement of the user 101, or both. In some aspects, a change in the source localization angle corresponds to a change in a zoom setting (e.g., an audio zoom setting, a visual zoom setting, or a combination of both, that may be set by the user 101). In a particular aspect, a change in a source output corresponds to a change between an audio source 221 generating sound and not generating sound. Alternatively, or in addition, a change in a source output can correspond to a change in a type of sound output by the audio source 221 (e.g., from noise to speech).

FIG. 2C is a diagram 250 of an illustrative aspect of operations associated with the priority assigner 142, in accordance with some examples of the present disclosure. The priority assigner 142 identifies a plurality of target regions 204 of a visual scene 220.

In a particular aspect, the priority assigner 142 determines the target regions 204 based on a gaze direction of the user 101 and a source localization angle (e.g., a field of view). To illustrate, the priority assigner 142 identifies a target region 204A that is centered (e.g., 0 degrees) along the gaze direction of the user 101 and has a shape (e.g., a circle with a particular diameter) that is based on a first portion of the source localization angle. As an example, a source localization angle (e.g., a field of view) is 60 degrees (e.g., −30 degrees to +30 degrees) and the target region 204A has a diameter that is based on a first portion (e.g., −5 degrees to +5 degrees) of the source localization angle from a central point of the field of view (e.g., an estimated gaze direction of the user 101).

The priority assigner 142 designates a second portion of the visual scene 220 that is outside the target region 204A as a target region 204B and has a shape (e.g., a donut-shape with a particular outer diameter) that is based on a second portion of the source localization angle. As an example, the target region 204B has an inner diameter that is based on the diameter of the target region 204A and has an outer diameter that is based on a second portion (e.g., −10 degrees to +10 degrees) of the source localization angle from the central point of the field of view (e.g., the estimated gaze direction).

The priority assigner 142 designates a remaining portion of the visual scene 220 that is outside the target region 204B as a target region 204C. As an example, the target region 204C has an inner diameter that is based on the diameter of the target region 204B. In some aspects, the remaining portion of the visual scene 220 has an outer width that is based on the source localization angle (e.g., −30 degrees to +30 degrees) from the central point of the field of view (e.g., the estimated gaze direction). In some aspects, the source localization angle is based on an expected field of view of a user (e.g., a user field of view), while the visual scene 220 is based on a field of view of an image generator (e.g., a camera, a game graphics generator, or both). In an example in which the image generator field of view is greater (e.g., wider) than the user field of view, the target region 204C can include a portion that is outside the source localization angle.

In some examples, the target region 204A corresponds to a central target region along the gaze direction of the user 101. The target region 204C corresponds to a peripheral target region outside of the gaze direction of the user 101. The target region 204B is between the central target region and the peripheral target region. In a particular aspect, the target region 204A corresponds to a cone of high auditory resolution around the gaze direction of the user 101. In a particular aspect, the target region 204B corresponds to intermediate auditory resolution and the target region 204C corresponds to lower auditory resolution. In some implementations, the priority assigner 142 estimates the gaze direction of the user 101 based on the head orientation 243, as described with reference to FIG. 2A.

According to some aspects, the source localization angle (e.g., −30 degrees to +30 degrees), the first portion (e.g., −5 degrees to +5 degrees), the second portion (e.g., −10 degrees to +10 degrees), or a combination thereof, are based on a configuration setting, default data, a user input, or a combination thereof. In a particular aspect, the source localization angle is (or portions thereof are) based on a field of view of a user, a field of view of a camera, a field of view of an extended reality (XR) device, a characteristic (e.g., a beamwidth, a beam angle, or both) of a microphone beamformer, or a combination thereof.

Each of the target regions 204 is associated with a target region priority. For example, the target region 204A is assigned a first target region priority, the target region 204B is assigned a second target region priority that is lower than the first target region priority, and the target region 204C is assigned a third target region priority that is lower than the second target region priority. It should be understood that the target regions 204 associated with three target region priorities is provided as an illustrative example, in other examples the target regions 204 can be associated with fewer than three or more than three target region priorities. It should be understood that the priority assigner 142 identifying three target regions in the visual scene 220 is provided as an illustrative example, in other examples the priority assigner 142 can identify fewer than three or more than three target regions in the visual scene 220.

The image data 127 corresponds to (e.g., includes) visual representations of the audio sources 221 in the visual scene 220 captured in one or more images. In an example, the image data 127 corresponds to a first visual representation of an audio source 221A (e.g., a person), a second visual representation of an audio source 221B (e.g., a bird), and a third visual representation of an audio source 221C (e.g., a car).

The priority assigner 142 uses various source detection techniques to determine, based on the image data 127, visual source positions of the audio sources 221 in the visual scene 220. In an example, the audio source 221A, the audio source 221B, and the audio source 221C have a first visual source position, a second visual source position, and a third visual source position, respectively, in the visual scene 220.

According to some aspects, the priority assigner 142 generates the visual source positions based on the audio data 123. For example, the priority assigner 142, in response to determining that the audio data 123A corresponds to a first audio type (e.g., speech) and that the image data 127 includes the first visual representation of a first audio source (e.g., a person) associated with the first audio type (e.g., speech), determines that the first audio source corresponds to the audio source 221A of the audio data 123A and that the audio source 221A has the first visual source position of the first audio source (e.g., the person).

In an illustrative example, the priority assigner 142 determines that multiple audio sources of the same type are indicated in the image data 127. In this example, a first audio source (e.g., a first person) of an audio source type (e.g., a speech source) has a first visual source position, and a second audio source (e.g., a second person) of the audio source type has a second visual source position in the visual scene 220. The priority assigner 142 determines that the audio source 221A of the audio source type (e.g., a speech source) has a first audio source position in the audio scene 202. The priority assigner 142, in response to determining that the first audio source position corresponds to the first visual source position, identifies the first audio source (e.g., the first person) in the visual scene 220 as the audio source 221A, and determines that the audio source 221A has the first visual source position in the visual scene 220.

According to some implementations, the priority assigner 142 assigns audio source priorities 223 to the audio sources 221 based at least in part on the visual source positions in the visual scene 220. For example, the priority assigner 142, in response to determining that a first visual source position of the audio source 221A is within the target region 204A having the first target region priority, assigns an audio source priority 223A that is based on the first target region priority to the audio source 221A. As another example, the priority assigner 142, in response to determining that a second visual source position of the audio source 221B is within the target region 204B associated with the second target region priority, assigns an audio source priority 223B that is based on the second target region priority to the audio source 221B. Similarly, the priority assigner 142, in response to determining that a third visual source position of the audio source 221C is within the target region 204C associated with the third target region priority, assigns an audio source priority 223C that is based on the third target region priority to the audio source 221C.

In a particular aspect, the priority assigner 142 assigns a higher priority to audio sources that are in a central target region in a gaze direction of the user 101 than to audio sources that are in a peripheral target region so that the audio sources in the central target region can be rendered with greater spatial accuracy. In some implementations, the priority assigner 142 determines the audio source priority 223A based on the target region priority of the target region 204A that includes the first visual source position, a source identifier of the audio source 221A, a source type of the audio source 221A, a visual element (e.g., a facial expression, a blinking light, etc.) of the audio source 221A, the source localization angle, the first visual source position, or a combination thereof.

According to some implementations, the priority assigner 142 determines an audio source priority 223A of the audio source 221A based on a weighted sum of priorities of various factors (e.g., a target region priority in the visual scene 220, a target region priority in the audio scene 202, a source identifier priority, a source type priority, a source output priority, a visual element priority, one or more additional priorities, or a combination thereof) associated with the audio source 221A. The priority assigner 142 generates the priority assignment 119 indicating the audio source priorities 223 assigned to the audio sources 221.

In a particular aspect, the priority assigner 142 updates audio source priorities 223 based on detecting a change. For example, the priority assigner 142 updates the audio source priorities 223 based on detecting a change in a source position of an audio source 221 in the audio scene 202, a change in a source position of an audio source 221 in the visual scene 220, a change in a gaze direction of the user 101, a change in a source localization angle, a change in a source output, a change in a visual element, a user input, a configuration setting, or a combination thereof.

In some examples, the audio scene 202 can include one or more audio sources that are not visually represented in the visual scene 220, such as an invisible audio source (e.g., an alarm), an audio source that is outside a range of an image sensor (e.g., that is behind the camera or too far from the camera), or a combination thereof. In some examples, an audio source priority 223A of an audio source 221A that is not visually represented in the visual scene 220 is based on an audio source position of the audio source 221A in the audio scene 202. An audio source priority 223B of an audio source 221B that is visually represented in the visual scene 220 is based on an audio source position of the audio source 221B in the audio scene 202, a visual source position of the audio source 221B in the visual scene 220, or both.

A technical advantage of the priority assigner 142 can include assigning a higher priority to audio sources that are likely to be of more interest to the user 101 to be rendered with higher spatial accuracy while assigning a lower priority to audio sources that are likely to be of less interest to the user 101 to conserve resources while rendering.

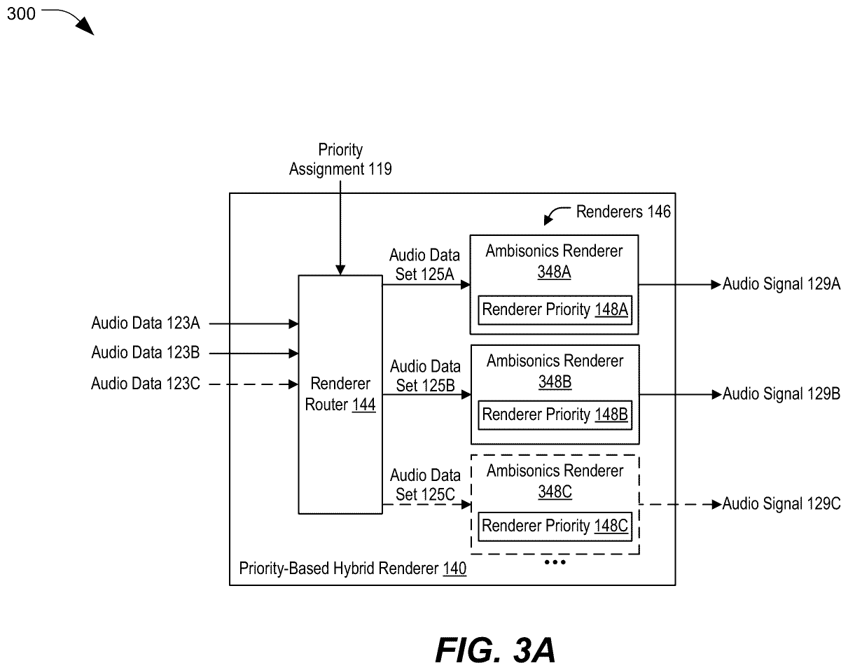

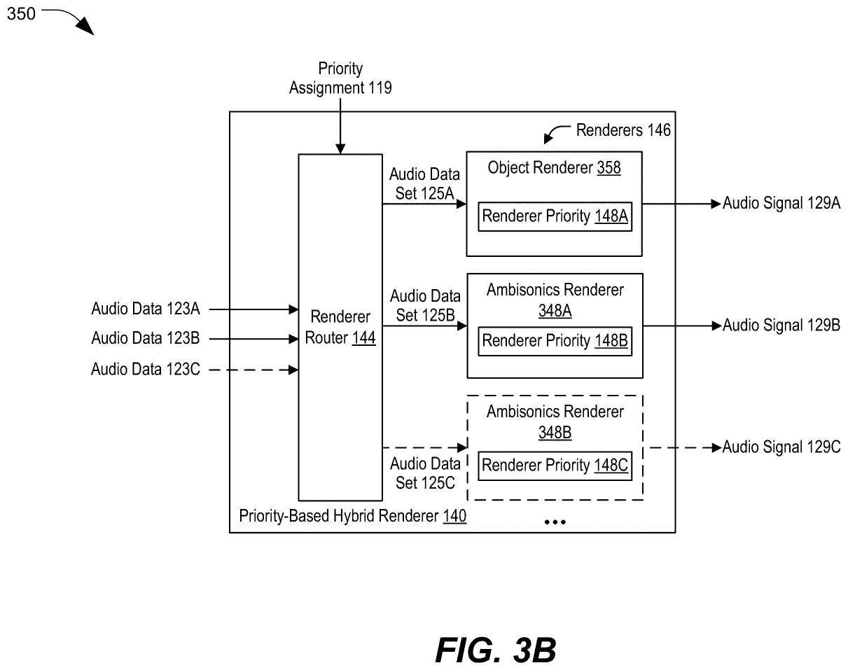

FIG. 3A is a diagram 300 of an illustrative aspect of the priority-based hybrid renderer 140, in accordance with some examples of the present disclosure. The renderers 146 include a plurality of ambisonics renderers, such as an ambisonics renderer 348A, an ambisonics renderer 348B, an ambisonics renderer 348C, one or more additional ambisonics renderers, or a combination thereof.

Each of the ambisonics renderers has a renderer priority 148. For example, the ambisonics renderer 348A, the ambisonics renderer 348B, and the ambisonics renderer 348C have the renderer priority 148A, the renderer priority 148B, and the renderer priority 148C, respectively. The renderer priority 148A is higher than the renderer priority 148B, and the renderer priority 148B is higher than the renderer priority 148C.

A higher priority ambisonics renderer performs higher order ambisonics rendering and has greater spatial accuracy. For example, the ambisonics renderer 348A performs higher order ambisonics rendering and has greater spatial accuracy as compared to the ambisonics renderer 348B, and the ambisonics renderer 348B performs higher order ambisonics rendering and has greater spatial accuracy as compared to the ambisonics renderer 348C. A lower priority ambisonics renderer uses fewer processing resources. For example, the ambisonics renderer 348C uses fewer processing resources as compared to the ambisonics renderer 348B, and the ambisonics renderer 348B uses fewer processing resources as compared to the ambisonics renderer 348A.

The renderer router 144 routes the audio data 123 to the ambisonics renderers 348 based on a comparison of the audio source priorities indicated by the priority assignment 119 and the renderer priorities 148. For example, the renderer router 144 provides the audio data set 125A including audio data of audio sources with audio source priorities that match the renderer priority 148A to the ambisonics renderer 348A. To illustrate, the renderer router 144, in response to determining that the audio source priority 223A of the audio source 221A matches the renderer priority 148A, includes the audio data 123A in the audio data set 125A. In a first example, the renderer router 144, in response to determining that the audio source priority 223B of the audio source 221B matches the renderer priority 148A, also includes the audio data 123B in the audio data set 125A. Alternatively, the renderer router 144, in response to determining that the audio source priority 223B of the audio source 221B matches the renderer priority 148B, includes the audio data 123B in the audio data set 125B. Similarly, in some examples, the renderer router 144, in response to determining that the audio source priority 223C of the audio source 221C matches the renderer priority 148C, includes the audio data 123C in the audio data set 125C.

The renderer router 144 routes the audio data sets 125 that include audio data of at least one audio source to the ambisonics renderers 348. For example, the renderer router 144, in response to determining that the audio data set 125A includes at least the audio data 123A, provides the audio data set 125A to the ambisonics renderer 348A. As another example, the renderer router 144, in response to determining that the audio data set 125B includes at least the audio data 123B, provides the audio data set 125B to the ambisonics renderer 348B. As yet another example, the renderer router 144, in response to determining that the audio data set 125C includes at least the audio data 123C, provides the audio data set 125C to the ambisonics renderer 348C.

According to some implementations, if an audio data set 125 corresponding to a renderer 146 is empty, the renderer router 144 moves up the audio data from a lower priority audio data set 125. In an example, the renderer router 144, in response to determining that the audio data set 125B is empty, provides the audio data set 125C to the ambisonics renderer 348B. In this example, the renderer router 144 provides a lower priority audio data set, if any, to the ambisonics renderer 348C instead of the audio data set 125C. In these implementations, higher priority renderers can be used to render lower priority audio sources when matching priority audio sources are absent.

Dashed lines are used to illustrate optional components. For example, the ambisonics renderer 348C is illustrated using a dashed line in FIG. 3A to indicate that the ambisonics renderer 348C is an optional component. In some implementations, the renderers 146 include three renderers, such as the ambisonics renderer 348A, the ambisonics renderer 348B, and the ambisonics renderer 348C. In other implementations, the renderers 146 can include fewer than three renderers, such as the ambisonics renderer 348A and the ambisonics renderer 348B and not the ambisonics renderer 348C. In yet other implementations, the renderers 146 can include more than three renderers.

It should be understood that the renderers 146 including the ambisonics renderers 348 is provided as an illustrative example. In other examples, the renderers 146 can include one or more types of scene-based renderers, one or more types of object-based renderers, or a combination thereof.

FIG. 3B is a diagram 350 of an illustrative aspect of the priority-based hybrid renderer 140, in accordance with some examples of the present disclosure. The renderers 146 include an object renderer 358, and one or more ambisonics renderers, such as an ambisonics renderer 348A, an ambisonics renderer 348B, one or more additional ambisonics renderers, or a combination thereof.

Each of the renderers 146 has a renderer priority 148. For example, the object renderer 358, the ambisonics renderer 348A, and the ambisonics renderer 348B have the renderer priority 148A, the renderer priority 148B, and the renderer priority 148C, respectively. The renderer priority 148A is higher than the renderer priority 148B, and the renderer priority 148B is higher than the renderer priority 148C.

A higher priority ambisonics renderer performs higher order ambisonics rendering and has greater spatial accuracy. For example, the ambisonics renderer 348A performs higher order ambisonics rendering and has greater spatial accuracy as compared to the ambisonics renderer 348B. The object renderer 358 has greater spatial accuracy as compared to the ambisonics renderer 348A.

According to an aspect, a lower priority ambisonics renderer uses fewer processing resources. For example, the ambisonics renderer 348B uses fewer processing resources as compared to the ambisonics renderer 348A. In addition, the ambisonics renderer 348A may use fewer processing resources as compared to the object renderer 358.

The renderer router 144 routes the audio data 123 to the renderers 146 based on a comparison of the audio source priorities indicated by the priority assignment 119 and the renderer priorities 148. For example, the renderer router 144, in response to determining that the audio source priority 223A of the audio source 221A matches the renderer priority 148A, includes the audio data 123A in the audio data set 125A.

The renderer router 144 routes the audio data sets 125 that include audio data of at least one audio source to the renderers 146. For example, the renderer router 144, in response to determining that the audio data set 125A includes at least the audio data 123A, provides the audio data set 125A to the object renderer 358.

According to some implementations, if an audio data set 125 corresponding to a renderer 146 is empty, the renderer router 144 moves up the audio data from a lower priority audio data set 125. In an example, the renderer router 144, in response to determining that the audio data set 125B is empty, provides the audio data set 125C to the ambisonics renderer 348A. In this example, the renderer router 144 provides a lower priority audio data set, if any, to the ambisonics renderer 348B instead of the audio data set 125C.

Dashed lines are used to illustrate optional components. For example, the ambisonics renderer 348B is illustrated using a dashed line in FIG. 3B to indicate that the ambisonics renderer 348B is an optional component. In some implementations, the renderers 146 include two ambisonics renderers, such as the ambisonics renderer 348A and the ambisonics renderer 348B. In other implementations, the renderers 146 can include fewer than two ambisonics renderers, such as the ambisonics renderer 348A and not the ambisonics renderer 348B. In yet other implementations, the renderers 146 can include more than two ambisonics renderers.

It should be understood that the renderers 146 including a single object renderer and one or more ambisonics renderers is provided as an illustrative example. In other examples, the renderers 146 can include one or more of a first type of renderer (e.g., an object-based renderer), one or more of a second type of renderer (e.g., a scene-based renderer), or a combination thereof.

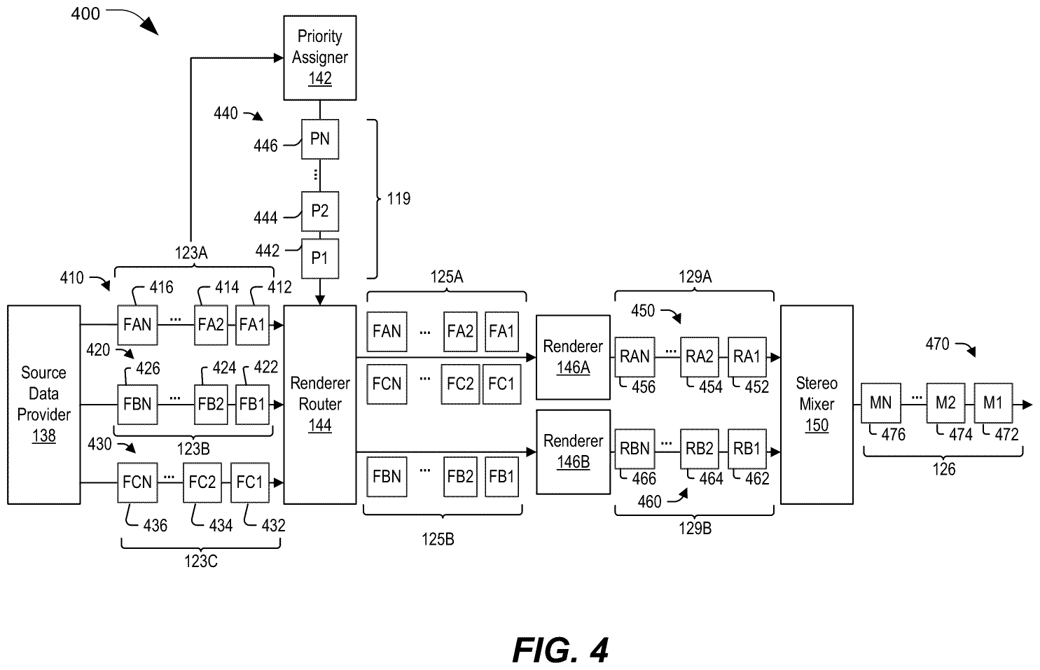

FIG. 4 is a diagram of an illustrative aspect of operation of components of the system 100 of FIG. 1, in accordance with some examples of the present disclosure.

Each of the priority assigner 142 and the renderer router 144 is configured to receive, from the source data provider 138, a sequence 410 of audio data samples of audio of a first audio source, such as a sequence of successively captured frames of the audio data 123A, illustrated as a first frame (FA1) 412, a second frame (FA2) 414, and one or more additional frames including an Nth frame (FAN) 416 (where N is an integer greater than two).

Each of the priority assigner 142 and the renderer router 144 is configured to receive, from the source data provider 138, a sequence 420 of audio data samples of audio of a second audio source, such as a sequence of successively captured frames of the audio data 123B, illustrated as a first frame (FB1) 422, a second frame (FB2) 424, and one or more additional frames including an Nth frame (FBN) 426.

Each of the priority assigner 142 and the renderer router 144 is configured to receive, from the source data provider 138, a sequence 430 of audio data samples of audio of a third audio source, such as a sequence of successively captured frames of the audio data 123C, illustrated as a first frame (FC1) 432, a second frame (FC2) 434, and one or more additional frames including an Nth frame (FCN) 436.

The priority assigner 142 is configured to output a sequence 440 of successive determinations of the priority assignment 119, illustrated as a first priority assignment (P1) 442, a second priority assignment (P2) 444, and one or more additional priority assignments including an Nth priority assignment (PN) 446. For example, the first priority assignment (P1) 442 indicates priorities for the first frame of each of the audio sources, the second priority assignment (P2) 444 indicates priorities for the second frame of each of the audio sources, etc.

The renderer router 144 is configured to route the frames of the sequence 410, the sequence 420, and the sequence 430, to the renderers 146 based on the determinations of the priority assignment 119. For example, the renderer router 144 is configured to route frames of the sequence 410 and frames of the sequence 430 to the renderer 146A as frames of the audio data set 125A to the renderer 146A. As another example, the renderer router 144 is configured to route frames of the sequence 420 to the renderer 146B as frames of the audio data set 125B to the renderer 146B.

The renderers 146 are configured to generate sequences of frames of the audio signals 129. For example, the renderer 146A is configured to render the frames of the sequence 410 and the frames of the sequence 430 to generate a sequence 450 of audio frames of the audio signal 129A, illustrated as a first frame (RA1) 452, a second frame (RA2) 454, and one or more additional frames including an Nth frame (RAN) 456. As another example, the renderer 146B is configured to render the frames of the sequence 420 to generate a sequence 460 of audio frames of the audio signal 129B, illustrated as a first frame (RB1) 462, a second frame (RB2) 464, and one or more additional frames including an Nth frame (RBN) 466.

The stereo mixer 150 is configured to mix the frames of the sequence 450 and frames of the sequence 460 to generate a sequence 470 of frames of the output audio signal 126, illustrated as a first frame (M1) 472, a second frame (M2) 474, and one or more additional frames including an Nth frame (MN) 476.

During operation, the priority assigner 142 processes the first frame (FA1) 412, the first frame (FB1) 422, and the first frame (FC1) 432 to generate the first priority assignment (P1) 442. The renderer router 144, based on the first priority assignment (P1) 442 indicating that a first audio source of the audio data 123A is assigned a first audio source priority that matches the renderer priority 148A, adds the first frame (FA1) 412 to the audio data set 125A. Similarly, the renderer router 144, based on the first priority assignment (P1) 442 indicating that a third audio source of the audio data 123C is assigned a third audio source priority that matches the renderer priority 148A, adds the first frame (FC1) 432 to the audio data set 125A. The renderer router 144, based on the first priority assignment (P1) 442 indicating that a second audio source of the audio data 123B is assigned a second audio source priority that matches the renderer priority 148B, adds the first frame (FB1) 422 to the audio data set 125B.

The renderer router 144 provides frames of the audio data set 125A to the renderer 146A. For example, the renderer router 144 provides the first frame (FA1) 412 and the first frame (FC1) 432 to the renderer 146A. Similarly, the renderer router 144 provides frames of the audio data set 125B to the renderer 146B. For example, the renderer router 144 provides the first frame (FB1) 422 to the renderer 146B.

The renderer 146A processes a frame of each set of audio data in the audio data set 125A to generate a frame of the audio signal 129A. For example, the renderer 146A renders the first frame (FA1) 412 and the first frame (FC1) 432 to generate a first frame (RA1) 452 of the sequence 450. Similarly, the renderer 146B processes a frame of each set of audio data in the audio data set 125B to generate a frame of the audio signal 129B. For example, the renderer 146B renders the first frame (FB1) 422 to generate a first frame (RB1) 462 of the sequence 460.

The stereo mixer 150 mixes a frame of the audio signal 129A and a frame of the audio signal 129B to generate a frame of the output audio signal 126. For example, the stereo mixer 150 mixes the first frame (RA1) 452 and the first frame (RB1) 462 to generate a first frame (M1) 472 of the sequence 470.

The priority assigner 142 processes the second frame (FA2) 414, the second frame (FB2) 424, and the second frame (FC2) 434 to generate the second priority assignment (P2) 444. The renderer router 144, based on the second priority assignment (P2) 444 indicating that audio source priorities remain unchanged, adds the second frame (FA2) 414 and the second frame (FC2) 434 to the audio data set 125A, and adds the second frame (FB2) 424 to the audio data set 125B. Alternatively, if the second priority assignment (P2) 444 indicates that the audio source priority of an audio source has changed to match a renderer priority of another renderer, the second frame of the audio source can be added to an audio data set of the other renderer.

The renderer router 144 provides frames of the audio data set 125A to the renderer 146A. For example, the renderer router 144 provides the second frame (FA2) 414 and the second frame (FC2) 434 to the renderer 146A. Similarly, the renderer router 144 provides frames of the audio data set 125B to the renderer 146B. For example, the renderer router 144 provides the second frame (FB2) 424 to the renderer 146B.

The renderer 146A renders frames of the audio data set 125A to generate a frame of the audio signal 129A. For example, the renderer 146A renders the second frame (FA2) 414 and the second frame (FC2) 434 to generate a second frame (RA2) 454 of the sequence 450. Similarly, the renderer 146B renders frames of the audio data set 125B to generate a frame of the audio signal 129B. For example, the renderer 146B renders the second frame (FB2) 424 to generate a second frame (RB2) 464 of the sequence 460.

The stereo mixer 150 mixes a frame of the audio signal 129A and a frame of the audio signal 129B to generate a frame of the output audio signal 126. For example, the stereo mixer 150 mixes the second frame (RA2) 454 and the second frame (RB2) 464 to generate a second frame (M2) 474 of the sequence 470.

Such processing continues with the priority assigner 142 processing the Nth frame (FAN) 416, the Nth frame (FBN) 426, and the Nth frame (FCN) 436 to generate the Nth priority assignment (PN) 446. The renderer router 144, based on the Nth priority assignment (PN) 446 indicating that audio source priorities remain unchanged, adds the Nth frame (FAN) 416 and the Nth frame (FCN) 436 to the audio data set 125A, and adds the Nth frame (FBN) 426 to the audio data set 125B. Alternatively, if the Nth priority assignment (PN) 446 indicates that the audio source priority of an audio source has changed to match a renderer priority of another renderer, the Nth frame of the audio source can be added to an audio data set of the other renderer.

The renderer router 144 provides frames of the audio data set 125A to the renderer 146A. For example, the renderer router 144 provides the Nth frame (FAN) 416 and the Nth frame (FCN) 436 to the renderer 146A. Similarly, the renderer router 144 provides frames of the audio data set 125B to the renderer 146B. For example, the renderer router 144 provides the Nth frame (FBN) 426 to the renderer 146B.

The renderer 146A renders frames of the audio data set 125A to generate a frame of the audio signal 129A. For example, the renderer 146A renders the Nth frame (FAN) 416 and the Nth frame (FCN) 436 to generate an Nth frame (RAN) 456 of the sequence 450. Similarly, the renderer 146B renders frames of the audio data set 125B to generate a frame of the audio signal 129B. For example, the renderer 146B renders the Nth frame (FBN) 426 to generate an Nth frame (RBN) 466 of the sequence 460.

The stereo mixer 150 mixes a frame of the audio signal 129A and a frame of the audio signal 129B to generate a frame of the output audio signal 126. For example, the stereo mixer 150 mixes the Nth frame (RAN) 456 and the Nth frame (RBN) 466 to generate an Nth frame (MN) 476 of the sequence 470.

By dynamically routing frames to renderers based on priority determinations, rendering for audio sources can be changed to have greater spatial accuracy or to conserve resources based on changes to audio source priority.

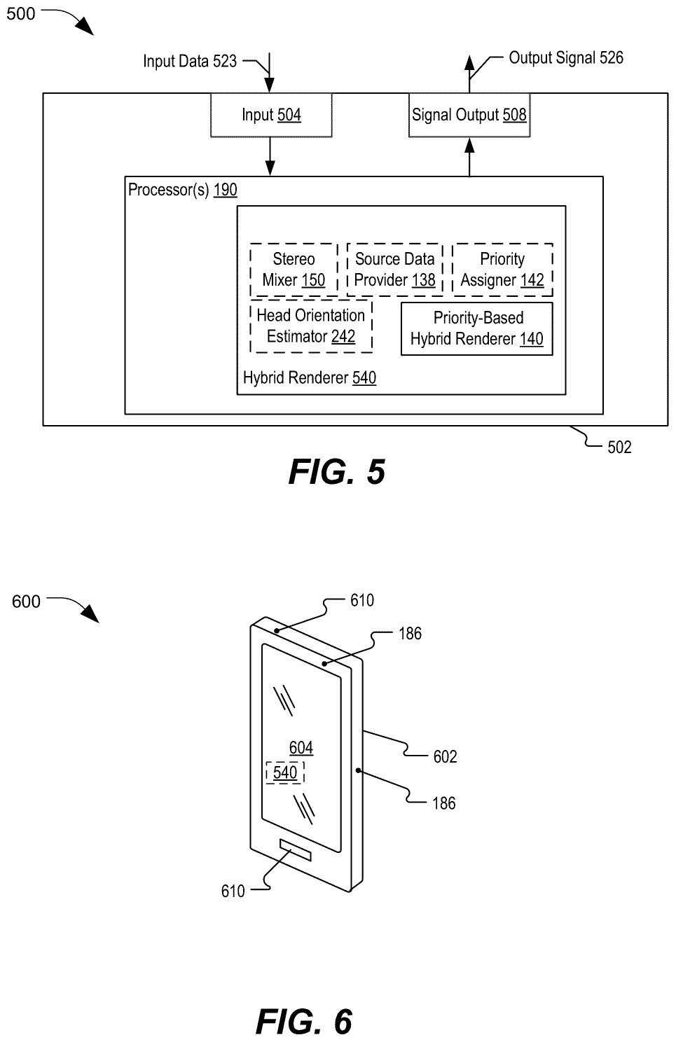

FIG. 5 depicts an implementation 500 of the device 102 as an integrated circuit 502 that includes the one or more processors 190. The integrated circuit 502 also includes an input 504, such as one or more bus interfaces, to enable input data 523 to be received for processing. The input data 523 includes one or more input audio signals, the audio data 123, the image data 127, the priority assignment 119, or a combination thereof. The integrated circuit 502 also includes a signal output 508, such as a bus interface, to enable sending of an output signal 526, such as the audio signals 129, the output audio signal 126, or a combination thereof.

The integrated circuit 502 includes a hybrid renderer 540. The hybrid renderer 540 includes the priority-based hybrid renderer 140. According to some implementations, the hybrid renderer 540 also includes the source data provider 138, the priority assigner 142, the stereo mixer 150, the head orientation estimator 242, or a combination thereof.

The integrated circuit 502 enables implementation of hybrid rendering as a component in a system that includes microphones, such as a mobile phone or tablet as depicted in FIG. 6, a headset as depicted in FIG. 7, a wearable electronic device as depicted in FIG. 8, a voice-controlled speaker system as depicted in FIG. 9, a virtual reality, mixed reality, or augmented reality headset as depicted in FIG. 10, or a vehicle as depicted in FIG. 11 or FIG. 12.

FIG. 6 depicts an implementation 600 in which the device 102 includes a mobile device 602, such as a phone or tablet, as illustrative, non-limiting examples. The mobile device 602 includes the one or more speakers 186, one or more microphones 610, and a display screen 604. Components of the one or more processors 190, including the hybrid renderer 540, are integrated in the mobile device 602 and are illustrated using dashed lines to indicate internal components that are not generally visible to a user of the mobile device 602.

In a particular example, the source data provider 138 operates to generate audio data of one or more higher-priority audio sources (e.g., the audio data 123A of an audio source 221A that is in a user's field of view) and the priority-based hybrid renderer 140 operates to generate the output audio signal 126 with the audio data of the higher-priority audio source(s) rendered to have greater spatial accuracy than audio data of lower-priority audio sources. In some aspects, user voice activity detected in an input audio signal received via the one or more microphones 610 is processed to perform one or more operations at the mobile device 602, such as to launch a graphical user interface or otherwise display other information associated with the user's speech at the display screen 604 (e.g., via an integrated “smart assistant” application).

According to some implementations, the priority-based hybrid renderer 140 provides a GUI indicating the priority assignment 119 to the display screen 604 and updates the priority assignment 119 based on user input from the user 101 of the mobile device 602. The priority-based hybrid renderer 140 generates the audio signals 129 based on the updated priority assignment 119. In a particular example, the output audio signal 126 is played back via the one or more speakers 186 to the user 101 of the mobile device 602. In a particular example, the output audio signal 126 provided via wireless transmission to the one or more speakers 186 integrated in earphones or a headset (not shown) that is worn by the user 101.

FIG. 7 depicts an implementation 700 in which the device 102 includes a headset device 702. The headset device 702 includes the one or more speakers 186 and a microphone 710. Components of the one or more processors 190, including the hybrid renderer 540, are integrated in the headset device 702.

In a particular example, the source data provider 138 operates to generate the audio data 123A of an audio source 221A, and the priority-based hybrid renderer 140 operates to generate the output audio signal 126 with the audio data 123A rendered to have greater spatial accuracy. In a particular example, the output audio signal 126 is played back via the one or more speakers 186 to the user 101 of the headset device 702. In some aspects, user voice activity detected in an input audio signal received via the microphone 710 may cause the headset device 702 to perform one or more operations at the headset device 702, to transmit audio data corresponding to the user voice activity to a second device (not shown) for further processing, or a combination thereof.

FIG. 8 depicts an implementation 800 in which the device 102 includes a wearable electronic device 802, illustrated as a “smart watch.” The hybrid renderer 540, the one or more speakers 186, and one or more microphones 810 are integrated into the wearable electronic device 802. In a particular example, the source data provider 138 operates to generate the audio data 123A of an audio source 221A (e.g., the user 101) and the priority-based hybrid renderer 140 operates to generate the output audio signal 126 with the audio data 123A rendered to have greater spatial accuracy.

In some aspects, user voice activity detected in an input audio signal received via the one or more microphones 810 is processed to perform one or more operations at the wearable electronic device 802, such as to launch a graphical user interface or otherwise display other information associated with the user's speech at a display screen 804 of the wearable electronic device 802. To illustrate, the wearable electronic device 802 may include a display screen that is configured to display a notification based on user speech detected by the wearable electronic device 802.

In a particular example, the wearable electronic device 802 includes a haptic device that provides a haptic notification (e.g., vibrates) in response to detection of user voice activity. For example, the haptic notification can cause a user to look at the wearable electronic device 802 to see a displayed notification indicating detection of a keyword spoken by the user. The wearable electronic device 802 can thus alert a user with a hearing impairment or a user wearing a headset that the user's voice activity is detected.

According to some implementations, the priority-based hybrid renderer 140 provides a GUI indicating the priority assignment 119 to the display screen 804. In some examples, the haptic device provides a haptic notification (e.g., vibrates) to alert the user that the GUI is displayed. The priority-based hybrid renderer 140 updates the priority assignment 119 based on user input from the user 101 of the wearable electronic device 802 and generates the audio signals 129 based on the updated priority assignment 119. In a particular example, the output audio signal 126 is played back via the one or more speakers 186 to the user 101 of the wearable electronic device 802.

FIG. 9 is an implementation 900 in which the device 102 includes a wireless speaker and voice activated device 902. The wireless speaker and voice activated device 902 can have wireless network connectivity and is configured to execute an assistant operation. The one or more processors 190 including the hybrid renderer 540, the one or more speakers 186, one or more microphones 910, or a combination thereof, are included in the wireless speaker and voice activated device 902.

During operation, the source data provider 138 operates to generate the audio data 123A of an audio source 221A (e.g., the user 101) and the priority-based hybrid renderer 140 operates to generate the output audio signal 126 with the audio data 123A rendered to have greater spatial accuracy. In a particular example, the output audio signal 126 is played back via the one or more speakers 186 to the user 101 of the wireless speaker and voice activated device 902.

In response to receiving a verbal command identified as user speech in an input audio signal received via the one or more microphones 910, the wireless speaker and voice activated device 902 can execute assistant operations, such as via execution of a voice activation system (e.g., an integrated assistant application). The assistant operations can include adjusting a temperature, playing music, turning on lights, etc. For example, the assistant operations are performed responsive to receiving a command after a keyword or key phrase (e.g., “hello assistant”).

FIG. 10 depicts an implementation 1000 in which the device 102 includes a portable electronic device that corresponds to a virtual reality, mixed reality, or augmented reality headset 1002. The hybrid renderer 540, the one or more speakers 186, one or more microphones 1010, or a combination thereof, are integrated into the headset 1002.

During operation, the source data provider 138 operates to generate the audio data 123A of an audio source 221A (e.g., the user 101) and the priority-based hybrid renderer 140 operates to generate the output audio signal 126 with the audio data 123A rendered to have greater spatial accuracy. A visual interface device is positioned in front of the user's eyes to enable display of augmented reality, mixed reality, or virtual reality images or scenes to the user while the headset 1002 is worn. In a particular example, the visual interface device is configured to display a notification indicating user speech detected in an input audio signal received via the one or microphones 1010.

According to some implementations, the priority-based hybrid renderer 140 provides a GUI indicating the priority assignment 119 to the visual interface device. The priority-based hybrid renderer 140 updates the priority assignment 119 based on user input from the user 101 of the headset 1002 and generates the audio signals 129 based on the updated priority assignment 119. In a particular example, the output audio signal 126 is played back via the one or more speakers 186 to the user 101 of the headset 1002.

FIG. 11 depicts an implementation 1100 in which the device 102 corresponds to, or is integrated within, a vehicle 1102, illustrated as a manned or unmanned aerial device (e.g., a package delivery drone). The hybrid render 540, the one or more speakers 186, one or more microphones 1110, or a combination thereof, are integrated into the vehicle 1102.

During operation, the source data provider 138 operates to generate the audio data 123A of an audio source 221A (e.g., the user 101) and the priority-based hybrid renderer 140 operates to generate the output audio signal 126 with the audio data 123A rendered to have greater spatial accuracy. In a particular example, the output audio signal 126 is played back via the one or more speakers 186 to the user 101 of the vehicle 1102. User voice activity detection can be performed on audio signals received from the one or more microphones 1110, such as for delivery instructions from an authorized user of the vehicle 1102.

FIG. 12 depicts another implementation 1200 in which the device 102 corresponds to, or is integrated within, a vehicle 1202, illustrated as a car. The vehicle 1202 includes the one or more processors 190 including the hybrid renderer 540. The vehicle 1202 also includes the one or more speakers 186 and one or more microphones 1210.

During operation, the source data provider 138 operates to generate the audio data 123A of an audio source 221A (e.g., the user 101) and the priority-based hybrid renderer 140 operates to generate the output audio signal 126 with the audio data 123A rendered to have greater spatial accuracy. According to some implementations, the priority-based hybrid renderer 140 provides a GUI indicating the priority assignment 119 to a display 1220. The priority-based hybrid renderer 140 updates the priority assignment 119 based on user input from the user 101 of the headset 1002 and generates the audio signals 129 based on the updated priority assignment 119. In a particular example, the output audio signal 126 is played back via the one or more speakers 186 to the user 101 of the vehicle 1202.

User voice activity detection can be performed on audio signals received from the one or more microphones 1210 such as for a voice command from an authorized passenger. For example, the user voice activity detection can be used to detect a voice command from an operator of the vehicle 1202 (e.g., from a parent to set a volume to 5 or to set a destination for a self-driving vehicle) and to disregard the voice of another passenger (e.g., a voice command from a child to set the volume to 10 or other passengers discussing another location). In some implementations, user voice activity detection can be performed based on an audio signal received from external microphones (e.g., the one or more microphones 1210), such as an authorized user of the vehicle.

In a particular implementation, in response to receiving a verbal command identified as user speech in the audio signals received from the one or more microphones 1210, a voice activation system initiates one or more operations of the vehicle 1202 based on one or more keywords (e.g., “unlock,” “start engine,” “play music,” “display weather forecast,” or another voice command), such as by providing feedback or information via the display 1220 or one or more speakers (e.g., the one or more speakers 186).

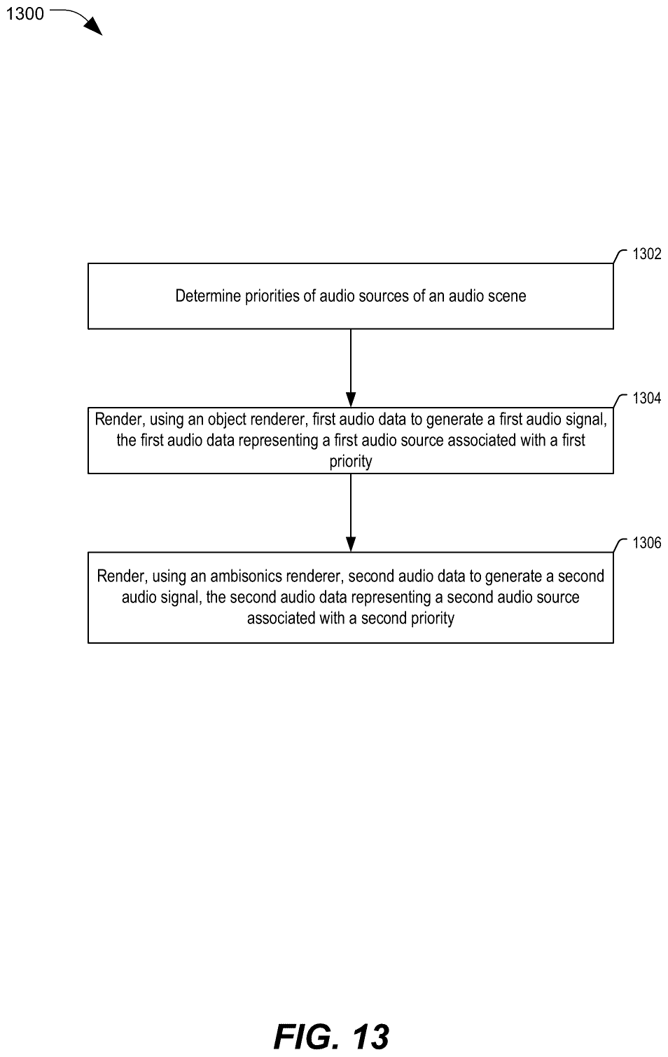

Referring to FIG. 13, a particular implementation of a method 1300 of performing hybrid rendering is shown. In a particular aspect, one or more operations of the method 1300 are performed by at least one of the priority assigner 142, the priority-based hybrid renderer 140, the renderer router 144, the renderers 146, the one or more processors 190, the device 102, the system 100 of FIG. 1, the ambisonics renderers 348, the object renderer 358, or a combination thereof.

The method 1300 includes determining priorities of audio sources of an audio scene, at 1302. For example, the priority assigner 142 assigns the audio source priorities 223 to the audio sources 221 of an audio scene 202, as described with reference to FIG. 2A, and the priority-based hybrid renderer 140 receives the priority assignment 119 from the priority assigner 142, as described with reference to FIG. 1.

The method 1300 also includes rendering, using an object renderer, first audio data to generate a first audio signal, at 1304. The first audio data represents a first audio source associated with a first priority. For example, the priority-based hybrid renderer 140 uses the object renderer 358 of FIG. 3B to render the audio data 123A to generate the audio signal 129A. The audio data 123A represents the audio source 221A of FIG. 2A associated with the audio source priority 223A.

The method 1300 further includes rendering, using a first ambisonics renderer, second audio data to generate a second audio signal, at 1306. The second audio data represents a second audio source associated with a second priority. For example, the priority-based hybrid renderer 140 uses the ambisonics renderer 348A of FIG. 3B to render the audio data 123C to generate the audio signal 129B. The audio data 123C represents the audio source 221C of FIG. 2A associated with the audio source priority 223C.

The method 1300 thus enables audio data of audio sources with different audio source priorities to be rendered using different renderers. For example, audio data of a higher priority audio source can be rendered using a higher spatial accuracy renderer, whereas resources can be conserved in rendering audio data of a lower priority audio source.

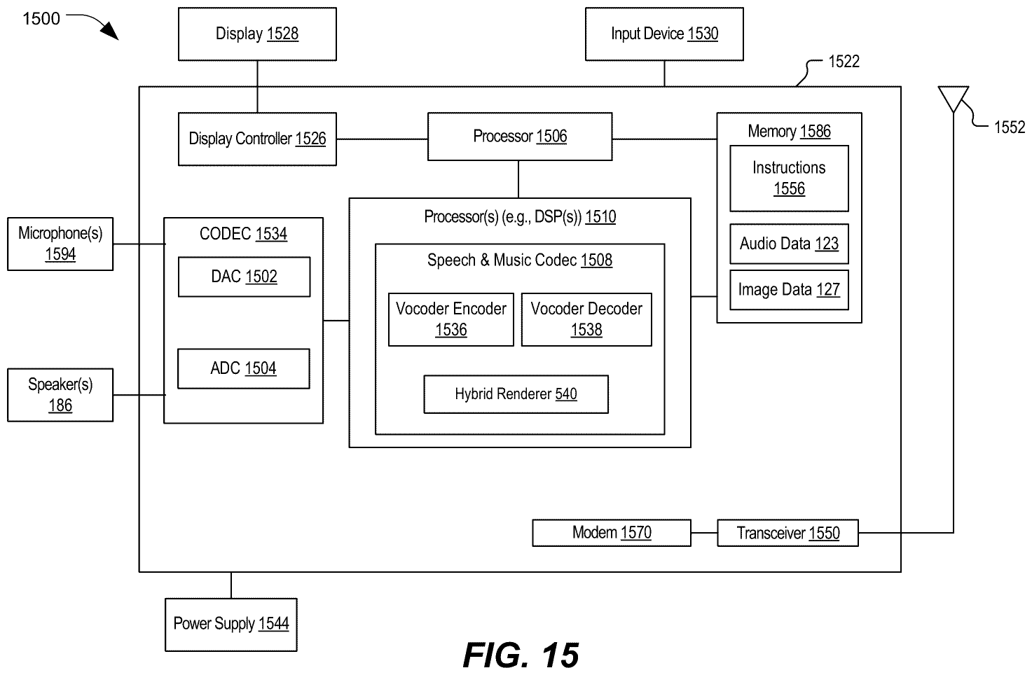

The method 1300 of FIG. 13 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1300 of FIG. 13 may be performed by a processor that executes instructions, such as described with reference to FIG. 15.

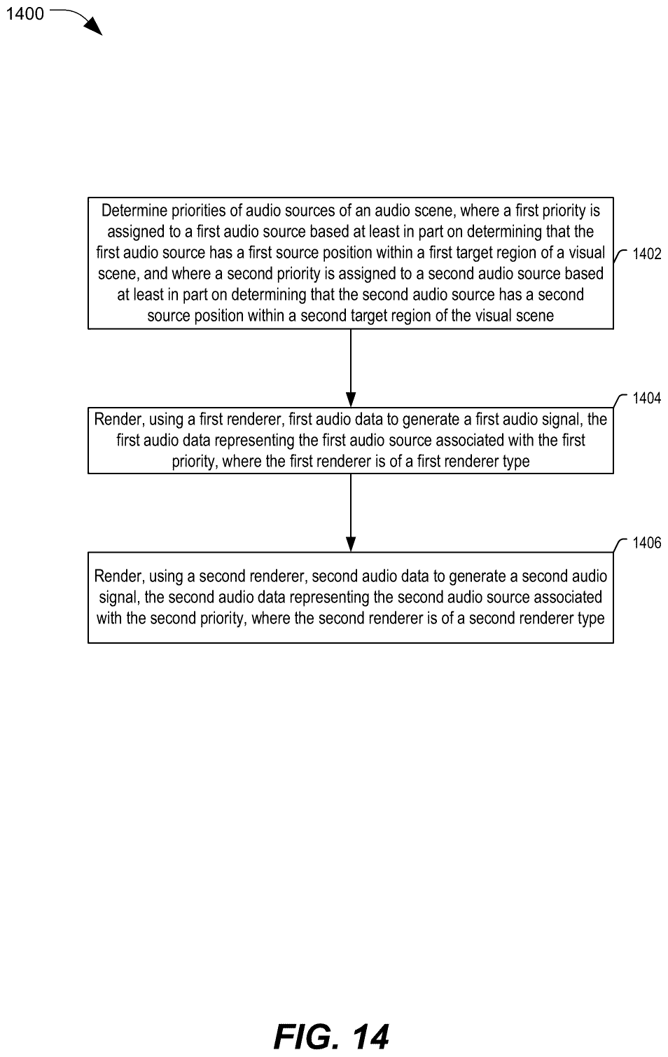

Referring to FIG. 14, a particular implementation of a method 1400 of performing hybrid rendering is shown. In a particular aspect, one or more operations of the method 1400 are performed by at least one of the priority assigner 142, the priority-based hybrid renderer 140, the renderer router 144, the renderers 146, the one or more processors 190, the device 102, the system 100 of FIG. 1, the ambisonics renderers 348, the object renderer 358, or a combination thereof.

The method 1400 includes determining priorities of audio sources of an audio scene, at 1402. A first priority is assigned to a first audio source based at least in part on determining that the first audio source has a first source position within a first target region of a visual scene, and a second priority is assigned to a second audio source based at least in part on determining that the second audio source has a second source position within a second target region of the visual scene. For example, the priority assigner 142 assigns the audio source priorities 223 to the audio sources 221 of an audio scene 202, and the priority-based hybrid renderer 140 receives the priority assignment 119 from the priority assigner 142. An audio source priority 223A is assigned to an audio source 221A of FIG. 2C based at least in part on determining that the audio source 221A has a visual source position within the target region 204A of the visual scene 220. An audio source priority 223C is assigned to the audio source 221C of FIG. 2C based at least in part on determining that the audio source 221C has a visual source position within the target region 204C of the visual scene 220.

The method 1400 also includes rendering, using a first renderer, first audio data to generate a first audio signal, at 1404. The first audio data represents the first audio source associated with the first priority, and the first renderer is of a first renderer type. For example, the priority-based hybrid renderer 140 uses the renderer 146A to render the audio data 123A to generate the audio signal 129A. The audio data 123A represents the audio source 221A associated with the audio source priority 223A. The renderer 146A is of a first renderer type (e.g., a scene-based renderer, an ambisonics renderer of a particular ambisonics order, or an object-based renderer).

The method 1400 further includes rendering, using a second renderer, second audio data to generate a second audio signal, at 1406. The second audio data represents the second audio source associated with the second priority, and the second renderer is of a second renderer type. For example, the priority-based hybrid renderer 140 uses the renderer 146B to render the audio data 123C to generate the audio signal 129C. The audio data 123C represents the audio source 221C associated with the audio source priority 223C. The renderer 146B is of a second renderer type (e.g., another of a scene-based renderer, an ambisonics renderer of a particular ambisonics order, or an object-based renderer).

In a particular aspect, the renderer 146B is of a different renderer type than the renderer 146A. For example, the renderer 146A includes the object renderer 358 and the renderer 146B includes the ambisonics renderer 348A. As another example, the renderer 146A includes the ambisonics renderer 348A configured to perform ambisonics rendering of a first order, and the renderer 146B includes the ambisonics renderer 348B configured to perform ambisonics rendering of a second order that is lower than the first order. In some implementations, the same renderer component can be used to perform different types (e.g., different orders) of rendering (e.g., corresponding to different complexity and resource usage) based on priority of audio data.

The method 1400 enables audio data of audio sources with different audio source priorities to be rendered using different renderers. For example, audio data of a higher priority audio source can be rendered using a higher spatial accuracy renderer, whereas resources can be conserved in rendering audio data of a lower priority audio source.

The method 1400 of FIG. 14 may be implemented by a FPGA device, an ASIC, a processing unit such as a CPU, a DSP, a controller, another hardware device, firmware device, or any combination thereof. As an example, the method 1400 of FIG. 14 may be performed by a processor that executes instructions, such as described with reference to FIG. 15.

Referring to FIG. 15, a block diagram of a particular illustrative implementation of a device is depicted and generally designated 1500. In various implementations, the device 1500 may have more or fewer components than illustrated in FIG. 15. In an illustrative implementation, the device 1500 may correspond to the device 102. In an illustrative implementation, the device 1500 may perform one or more operations described with reference to FIGS. 1-14.

In a particular implementation, the device 1500 includes a processor 1506 (e.g., a CPU). The device 1500 may include one or more additional processors 1510 (e.g., one or more DSPs). In a particular aspect, the one or more processors 190 of FIG. 1 correspond to the processor 1506, the processors 1510, or a combination thereof. The processors 1510 may include a speech and music coder-decoder (CODEC) 1508 that includes a voice coder (“vocoder”) encoder 1536, a vocoder decoder 1538, the hybrid renderer 540, or a combination thereof.

The device 1500 may include a memory 1586 and a CODEC 1534. The memory 1586 may include instructions 1556, that are executable by the one or more additional processors 1510 (or the processor 1506) to implement the functionality described with reference to the hybrid renderer 540. The device 1500 may include a modem 1570 coupled, via a transceiver 1550, to an antenna 1552.

The device 1500 may include a display 1528 coupled to a display controller 1526. The one or more speakers 186 and one or more microphones 1594 may be coupled to the CODEC 1534. The CODEC 1534 may include a digital-to-analog converter (DAC) 1502, an analog-to-digital converter (ADC) 1504, or both. In a particular implementation, the CODEC 1534 may receive analog signals from the one or more microphones 1594, convert the analog signals to digital signals using the analog-to-digital converter 1504, and provide the digital signals to the speech and music codec 1508. The speech and music codec 1508 may process the digital signals, and the digital signals may further be processed by the hybrid renderer 540. In a particular implementation, the speech and music codec 1508 may provide digital signals (e.g., the output audio signal 126) to the CODEC 1534. The CODEC 1534 may convert the digital signals to analog signals using the digital-to-analog converter 1502 and may provide the analog signals to the one or more speakers 186.

In a particular implementation, the device 1500 may be included in a system-in-package or system-on-chip device 1522. In a particular implementation, the memory 1586, the processor 1506, the processors 1510, the display controller 1526, the CODEC 1534, and the modem 1570 are included in the system-in-package or system-on-chip device 1522. In a particular implementation, an input device 1530 and a power supply 1544 are coupled to the system-in-package or the system-on-chip device 1522. Moreover, in a particular implementation, as illustrated in FIG. 15, the display 1528, the input device 1530, the one or more speakers 186, the one or more microphones 1594, the antenna 1552, and the power supply 1544 are external to the system-in-package or the system-on-chip device 1522. In a particular implementation, each of the display 1528, the input device 1530, the one or more speakers 186, the one or more microphones 1594, the antenna 1552, and the power supply 1544 may be coupled to a component of the system-in-package or the system-on-chip device 1522, such as an interface or a controller.

The device 1500 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for determining priorities of audio sources of an audio scene. For example, the means for determining priorities can correspond to the priority assigner 142, the priority-based hybrid renderer 140, the one or more processors 190, the device 102, the system 100 of FIG. 1, the processor 1506, the additional processors 1510, one or more other circuits or components configured to determine priorities of audio sources, or any combination thereof.

The apparatus also includes means for rendering, using an object renderer, first audio data to generate a first audio signal, the first audio data representing a first audio source associated with a first priority. For example, the means for rendering using the object renderer can correspond to the renderers 146, the priority-based hybrid renderer 140, the one or more processors 190, the device 102, the system 100 of FIG. 1, the object renderer 358 of FIG. 3B, the processor 1506, the additional processors 1510, one or more other circuits or components configured to render using an object renderer, or any combination thereof.

The apparatus further includes means for rendering, using an ambisonics renderer, second audio data to generate a second audio signal, the second audio data representing a second audio source associated with a second priority. For example, the means for rendering using the ambisonics renderer can correspond to the renderers 146, the priority-based hybrid renderer 140, the one or more processors 190, the device 102, the system 100 of FIG. 1, the ambisonics renderers 348 of FIG. 3B, the processor 1506, the additional processors 1510, one or more other circuits or components configured to render using an ambisonics renderer, or any combination thereof.

In some implementations, a non-transitory computer-readable medium (e.g., a computer-readable storage device, such as the memory 1586) includes instructions (e.g., the instructions 1556) that, when executed by one or more processors (e.g., the one or more processors 1510 or the processor 1506), cause the one or more processors to determine priorities (e.g., the audio source priorities 223) of audio sources (e.g., the audio sources 221) of an audio scene (e.g., the audio scene 202). The instructions also cause the one or more processors to render, using an object renderer (e.g., the object renderer 358), first audio data (e.g., the audio data 123A) to generate a first audio signal (e.g., the audio signal 129A), the first audio data representing a first audio source (e.g., the audio source 221A) associated with a first priority (e.g., the audio source priority 223A). The instructions further cause the one or more processors to render, using a second renderer (e.g., the ambisonics renderer 348A or the ambisonics renderer 348B), second audio data (e.g., the audio data 123B or the audio data 123C) to generate a second audio signal (e.g., the audio signal 129B or the audio signal 129C), the second audio data representing a second audio source (e.g., the audio source 221B or the audio source 221C) associated with a second priority (e.g., the audio source priority 223B or the audio source priority 223C).

Particular aspects of the disclosure are described below in sets of interrelated Examples:

According to Example 1, a device includes: a memory configured to store first audio data and second audio data; and one or more processors coupled to the memory and configured to determine priorities of audio sources of an audio scene; render, using an object renderer, the first audio data to generate a first audio signal, wherein the first audio data represents a first audio source associated with a first priority; and render, using a first ambisonics renderer, the second audio data to generate a second audio signal, wherein the second audio data represents a second audio source associated with a second priority.

Example 2 includes the device of Example 1, wherein the object renderer provides a higher spatial accuracy than the first ambisonics renderer.

Example 3 includes the device of Example 1 or Example 2, wherein the first ambisonics renderer uses fewer processing resources as compared to the object renderer.

Example 4 includes the device of any of Examples 1 to 3, wherein the one or more processors are configured to: determine a field of view of a user; and assign the first priority to the first audio source based at least in part on a determination that a first source position of the first audio source is within the field of view.

Example 5 includes the device of Example 4, wherein the field of view corresponds to a cone in forward-looking direction from the head of the user.

Example 6 includes the device of any of Examples 1 to 5, wherein the one or more processors are configured to: estimate a head orientation of a user; based on the head orientation and a first source position of the first audio source, determine that the user is facing the first audio source; and assign the first priority to the first audio source based on the determination that the user is facing the first audio source.

Example 7 includes the device of any of Examples 1 to 6, wherein the one or more processors are configured to assign a priority to an audio source based at least in part on a source position of the audio source, a source identifier of the audio source, a source type of the audio source, a source output of the audio source, a source localization angle, or a combination thereof.

Example 8 includes the device of any of Examples 1 to 7, wherein the one or more processors are configured to assign a priority to an audio source based at least in part on an audio source position of the audio source in an audio scene, a visual source position of the audio source in a visual scene, or both.

Example 9 includes the device of any of Examples 1 to 8, wherein the one or more processors are configured to assign the first priority to the first audio source based at least in part on determining that the first audio source has a first source position within a central target region of a visual scene; and assign the second priority to the second audio source based at least in part on determining that the second audio source has a second source position within a peripheral target region of the visual scene.

Example 10 includes the device of Example 9, wherein the one or more processors are configured to assign a third priority to a third audio source based at least in part on determining that the third audio source has a third source position that is in a particular target region between the central target region and the peripheral target region; and render, using a second ambisonics renderer, third audio data to generate a third audio signal, wherein the third audio data represents the third audio source, and wherein the second ambisonics renderer is a higher-order ambisonics renderer than the first ambisonics renderer.

Example 11 includes the device of any of Examples 1 to 10, wherein the one or more processors are configured to: based on determining that a first renderer priority of the object renderer matches the first priority of the first audio source, select the object renderer to render the first audio data; and based on determining that a second renderer priority of the first ambisonics renderer matches the second priority of the second audio source, select the first ambisonics renderer to render the second audio data.

Example 12 includes the device of any of Examples 1 to 11, wherein the one or more processors are configured to assign a priority to an audio source based at least in part on determining whether a source position of the audio source is within one or more target regions.

Example 13 includes the device of Example 12, wherein the one or more target regions are based on at least one of a gaze direction of a user, or a source localization angle, a source output.

Example 14 includes the device of any of Examples 1 to 13, wherein the one or more processors are configured to update the priorities based on a change in a source position, a change in a gaze direction of a user, a change in a source localization angle, a change in a source output, or a combination thereof.

Example 15 includes the device of Example 14, wherein the one or more processors are configured to estimate the change in the gaze direction based on detecting a head rotation of the user.

Example 16 includes the device of Example 14 or Example 15, wherein the one or more processors are configured to determine the change in the source position based on detecting a movement of an audio source.

Example 17 includes the device of any of Examples 1 to 16, wherein the one or more processors are configured to mix the first audio signal and the second audio signal to generate an output audio signal.

Example 18 includes the device of any of Examples 1 to 17, wherein the one or more processors are configured to apply a first gain to the first audio signal to generate a first gain adjusted signal; apply a second gain to the second audio signal to generate a second gain adjusted signal, wherein the first gain is higher than the second gain; and mix the first gain adjusted signal and the second gain adjusted signal to generate an output audio signal.

Example 19 includes the device of any of Examples 1 to 18, wherein the one or more processors are configured to, based on determining that a multi-render criterion is satisfied, use multiple renderers including the object renderer and the first ambisonics renderer.

Example 20 includes the device of Example 19, wherein the one or more processors are configured to determine that the multi-render criterion is satisfied based on determining that a count of the audio sources is greater than a count threshold, that available memory is less than a memory threshold, that remaining battery charge is less than a battery threshold, that a user setting indicates that multiple renderers are to be used, that at least two of the audio sources have source positions in different target regions, or a combination thereof.

Example 21 includes the device of Example 19 or Example 20, wherein the one or more processors are configured to, based on determining that the multi-render criterion is not satisfied, transition from using the multiple renderers to using a single renderer to generate an output audio signal.

Example 22 includes the device of any of Examples 1 to 21, wherein the first audio source is live, and wherein the second audio source is virtual.

Example 23 includes the device of any of Examples 1 to 22 and further includes one or more microphones, wherein the one or more processors are configured to receive the first audio data from the one or more microphones.

Example 24 includes the device of any of Examples 1 to 23, wherein the one or more processors are further configured to apply audio source extraction to audio data to generate the first audio data and the second audio data.

According to Example 25, a method includes determining priorities of audio sources of an audio scene; rendering, using an object renderer, first audio data to generate a first audio signal, the first audio data representing a first audio source associated with a first priority; and rendering, using a first ambisonics renderer, second audio data to generate a second audio signal, the second audio data representing a second audio source associated with a second priority.

Example 26 includes the method of Example 25, wherein the object renderer provides a higher spatial accuracy than the first ambisonics renderer.

Example 27 includes the method of Example 25 or Example 26, wherein the first ambisonics renderer uses fewer processing resources as compared to the object renderer.

Example 28 includes the method of any of Examples 25 to 27, and further includes: determining a field of view of a user; and assigning the first priority to the first audio source based at least in part on a determination that a first source position of the first audio source is within the field of view.

Example 29 includes the method of Example 28, wherein the field of view corresponds to a cone in forward-looking direction from the head of the user.

Example 30 includes the method of any of Examples 25 to 29, and further includes: estimating a head orientation of a user; based on the head orientation and a first source position of the first audio source, determining that the user is facing the first audio source; and assigning the first priority to the first audio source based on the determination that the user is facing the first audio source.

Example 31 includes the method of any of Examples 25 to 30, and further includes assigning a priority to an audio source based at least in part on a source position of the audio source, a source identifier of the audio source, a source type of the audio source, a source output of the audio source, a source localization angle, or a combination thereof.

Example 32 includes the method of any of Examples 25 to 31, and further includes assigning a priority to an audio source based at least in part on an audio source position of the audio source in an audio scene, a visual source position of the audio source in a visual scene, or both.

Example 33 includes the method of any of Examples 25 to 32, and further includes: assigning the first priority to the first audio source based at least in part on determining that the first audio source has a first source position within a central target region of a visual scene; and assigning the second priority to the second audio source based at least in part on determining that the second audio source has a second source position within a peripheral target region of the visual scene.

Example 34 includes the method of Example 33, and further includes: assigning a third priority to a third audio source based at least in part on determining that the third audio source has a third source position that is in a particular target region between the central target region and the peripheral target region; and rendering, using a second ambisonics renderer, third audio data to generate a third audio signal, the third audio data representing the third audio source, wherein the second ambisonics renderer is a higher-order ambisonics renderer than the first ambisonics renderer.

Example 35 includes the method of any of Examples 25 to 34, and further includes: based on determining that a first renderer priority of the object renderer matches the first priority of the first audio source, selecting the object renderer to render the first audio data; and based on determining that a second renderer priority of the first ambisonics renderer matches the second priority of the second audio source, selecting the first ambisonics renderer to render the second audio data.

Example 36 includes the method of any of Examples 25 to 35, and further includes assigning a priority to an audio source based at least in part on determining whether a source position of the audio source is within one or more target regions.

Example 37 includes the method of Example 36, wherein the one or more target regions are based on at least one of a gaze direction of a user, or a source localization angle, a source output.

Example 38 includes the method of any of Examples 25 to 37, and further includes updating the priorities based on a change in a source position, a change in a gaze direction of a user, a change in a source localization angle, a change in a source output, or a combination thereof.

Example 39 includes the method of Example 38, and further includes estimating the change in the gaze direction based on detecting a head rotation of the user.

Example 40 includes the method of Example 38 or Example 39, and further includes determining the change in the source position based on detecting a movement of an audio source.

Example 41 includes the method of any of Examples 25 to 40, and further includes mixing the first audio signal and the second audio signal to generate an output audio signal.

Example 42 includes the method of any of Examples 25 to 41, and further includes: applying a first gain to the first audio signal to generate a first gain adjusted signal; applying a second gain to the second audio signal to generate a second gain adjusted signal, wherein the first gain is higher than the second gain; and mixing the first gain adjusted signal and the second gain adjusted signal to generate an output audio signal.

Example 43 includes the method of any of Examples 25 to 42, and further includes, based on determining that a multi-render criterion is satisfied, using multiple renderers including the object renderer and the first ambisonics renderer.

Example 44 includes the method of Example 43, and further includes determining that the multi-render criterion is satisfied based on determining that a count of the audio sources is greater than a count threshold, that available memory is less than a memory threshold, that remaining battery charge is less than a battery threshold, that a user setting indicates that multiple renderers are to be used, that at least two of the audio sources have source positions in different target regions, or a combination thereof.

Example 45 includes the method of Example 43 or Example 44, and further includes, based on determining that the multi-render criterion is not satisfied, transitioning from using the multiple renderers to using a single renderer to generate an output audio signal.

Example 46 includes the method of any of Examples 25 to 45, wherein the first audio source is live, and wherein the second audio source is virtual.

Example 47 includes the method of any of Examples 25 to 46, and further includes receiving the first audio data from one or more microphones.

Example 48 includes the method of any of Examples 25 to 47, and further includes applying audio source extraction to audio data to generate the first audio data and the second audio data.

Example 49 includes the method of any of Examples 25 to 48, wherein a priority is assigned to an audio source based at least in part on a source position of the audio source in a visual scene.

Example 50 includes the method of any of Examples 25 to 49, wherein the first priority is assigned to the first audio source based at least in part on determining that the first audio source has a first source position within a central target region of a visual scene, and wherein the second priority is assigned to the second audio source based at least in part on determining that the second audio source has a second source position within a peripheral target region of the visual scene.

Example 51 includes the method of any of Examples 25 to 50, wherein target regions have corresponding region priorities, and wherein an audio source is assigned a priority based on a region priority of a particular target region based at least in part on determining that a source position of the audio source is within the particular target region.

Example 52 includes the method of Example 51, wherein the target regions are based on at least one of a gaze direction of a user, a source localization angle, or a source output.

Example 53 includes the method of any of Examples 25 to 52, and further includes updating the priorities based on a change in a source position, a change in a gaze direction of a user, a change in a source localization angle, a change in a source output, or a combination thereof.

According to Example 54, a device includes: a memory configured to store instructions; and a processor configured to execute the instructions to perform the method of any of Examples 25 to 53.

According to Example 55, a non-transitory computer-readable medium stores instructions that, when executed by a processor, cause the processor to perform the method of any of Examples 25 to 53.

According to Example 56, an apparatus includes means for carrying out the method of any of Example 25 to Example 53.

According to Example 57, a non-transitory computer readable medium stores instructions that, when executed by one or more processors, cause the one or more processors to: determine priorities of audio sources of an audio scene; render, using an object renderer, first audio data to generate a first audio signal, the first audio data representing a first audio source associated with a first priority; and render, using an ambisonics renderer, second audio data to generate a second audio signal, the second audio data representing a second audio source associated with a second priority.

Example 58 includes the non-transitory computer readable medium of Example 57, wherein the instructions, when executed by the one or more processors, cause the one or more processors to mix the first audio signal and the second audio signal to generate an output audio signal.

According to Example 59, an apparatus includes: means for determining priorities of audio sources of an audio scene; means for rendering, using an object renderer, first audio data to generate a first audio signal, the first audio data representing a first audio source associated with a first priority; and means for rendering, using an ambisonics renderer, second audio data to generate a second audio signal, the second audio data representing a second audio source associated with a second priority.

Example 60 includes the apparatus of Example 59, wherein the means for determining priorities, the means for rendering first audio data, and the means for rendering second audio data are integrated into at least one of a communication device, a mobile device, a computer, a display device, a television, a gaming console, a music player, a vehicle, a headset, an augmented reality headset, a mixed reality headset, a virtual reality headset, ear phones, an aerial vehicle, a home automation system, a voice-activated device, a wireless speaker and voice activated device, or an internet-of-things (IoT) device.

According to Example 61, a device includes a memory configured to store first audio data and second audio data. The device also includes one or more processors coupled to the memory and configured to: determine priorities of audio sources of an audio scene, wherein a first priority is assigned to a first audio source based at least in part on a determination that the first audio source has a first source position within a first target region of a visual scene, and wherein a second priority is assigned to a second audio source based at least in part on a determination that the second audio source has a second source position within a second target region of the visual scene; render, using a first renderer, the first audio data to generate a first audio signal, wherein the first audio data represents the first audio source associated with the first priority, and wherein the first renderer is of a first renderer type; and render, using a second renderer, the second audio data to generate a second audio signal, wherein the second audio data represents the second audio source associated with the second priority, and wherein the second renderer is of a second renderer type.

Example 62 includes the device of Example 61, wherein the first renderer includes an object renderer and the second renderer includes an ambisonics renderer.

Example 63 includes the device of Example 61 or Example 62, wherein the first renderer includes a higher order ambisonics renderer than an ambisonics renderer included in the second renderer.

According to Example 64, a method includes: determining priorities of audio sources of an audio scene, wherein a first priority is assigned to a first audio source based at least in part on determining that the first audio source has a first source position within a first target region of a visual scene, and wherein a second priority is assigned to a second audio source based at least in part on determining that the second audio source has a second source position within a second target region of the visual scene; rendering, using a first renderer, first audio data to generate a first audio signal, the first audio data representing the first audio source associated with the first priority, wherein the first renderer is of a first renderer type; and rendering, using a second renderer, second audio data to generate a second audio signal, the second audio data representing the second audio source associated with the second priority, wherein the second renderer is of a second renderer type.

Example 65 includes the method of Example 64, wherein the first renderer includes an object renderer and the second renderer includes an ambisonics renderer.

Example 66 includes the method of Example 64 or Example 65, wherein the first renderer includes a higher order ambisonics renderer than an ambisonics renderer included in the second renderer.

According to Example 67, a device includes: a memory configured to store instructions; and a processor configured to execute the instructions to perform the method of any of Examples 64 to 66.

According to Example 68, a non-transitory computer-readable medium stores instructions that, when executed by a processor, cause the processor to perform the method of any of Examples 64 to 66.

According to Example 69, an apparatus includes means for carrying out the method of any of Example 64 to Example 66.

According to Example 70, a non-transitory computer-readable medium includes instructions that, when executed by one or more processors, cause the one or more processors to: determine priorities of audio sources of an audio scene, wherein a first priority is assigned to a first audio source based at least in part on determining that the first audio source has a first source position within a first target region of a visual scene, and wherein a second priority is assigned to a second audio source based at least in part on determining that the second audio source has a second source position within a second target region of the visual scene; render, using a first renderer, first audio data to generate a first audio signal, the first audio data representing the first audio source associated with the first priority, wherein the first renderer is of a first renderer type; and render, using a second renderer, second audio data to generate a second audio signal, the second audio data representing the second audio source associated with the second priority, wherein the second renderer is of a second renderer type.

According to Example 71, an apparatus includes: means for determining priorities of audio sources of an audio scene, wherein a first priority is assigned to a first audio source based at least in part on determining that the first audio source has a first source position within a first target region of a visual scene, and wherein a second priority is assigned to a second audio source based at least in part on determining that the second audio source has a second source position within a second target region of the visual scene; means for rendering, using a first renderer, first audio data to generate a first audio signal, the first audio data representing the first audio source associated with the first priority, wherein the first renderer is of a first renderer type; and means for rendering, using a second renderer, second audio data to generate a second audio signal, the second audio data representing the second audio source associated with the second priority, wherein the second renderer is of a second renderer type.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store first audio data and second audio data; and
one or more processors coupled to the memory and configured to:
determine priorities of audio sources of an audio scene;
render, using an object renderer, the first audio data to generate a first audio signal, wherein the first audio data represents a first audio source associated with a first priority; and
render, using a first ambisonics renderer, the second audio data to generate a second audio signal, wherein the second audio data represents a second audio source associated with a second priority.

2. The device of claim 1, wherein the object renderer provides a higher spatial accuracy than the first ambisonics renderer.

3. The device of claim 1, wherein the first ambisonics renderer uses fewer processing resources as compared to the object renderer.

4. The device of claim 1, wherein the one or more processors are configured to:
determine a field of view of a user; and
assign the first priority to the first audio source based at least in part on a determination that a first source position of the first audio source is within the field of view.

5. The device of claim 4, wherein the field of view corresponds to a cone in forward-looking direction from the head of the user.

6. The device of claim 1, wherein the one or more processors are configured to:
estimate a head orientation of a user;
based on the head orientation and a first source position of the first audio source, determine that the user is facing the first audio source; and
assign the first priority to the first audio source based on the determination that the user is facing the first audio source.

7. The device of claim 1, wherein the one or more processors are configured to assign a priority to an audio source based at least in part on a source position of the audio source, a source identifier of the audio source, a source type of the audio source, a source output of the audio source, a source localization angle, or a combination thereof.

8. The device of claim 1, wherein the one or more processors are configured to assign a priority to an audio source based at least in part on an audio source position of the audio source in an audio scene, a visual source position of the audio source in a visual scene, or both.

9. The device of claim 1, wherein the one or more processors are configured to:
assign the first priority to the first audio source based at least in part on determining that the first audio source has a first source position within a central target region of a visual scene; and
assign the second priority to the second audio source based at least in part on determining that the second audio source has a second source position within a peripheral target region of the visual scene.

10. The device of claim 9, wherein the one or more processors are configured to:
assign a third priority to a third audio source based at least in part on determining that the third audio source has a third source position that is in a particular target region between the central target region and the peripheral target region; and
render, using a second ambisonics renderer, third audio data to generate a third audio signal, wherein the third audio data represents the third audio source, and wherein the second ambisonics renderer is a higher-order ambisonics renderer than the first ambisonics renderer.

11. The device of claim 1, wherein the one or more processors are configured to:
based on determining that a first renderer priority of the object renderer matches the first priority of the first audio source, select the object renderer to render the first audio data; and
based on determining that a second renderer priority of the first ambisonics renderer matches the second priority of the second audio source, select the first ambisonics renderer to render the second audio data.

12. The device of claim 1, wherein the one or more processors are configured to assign a priority to an audio source based at least in part on determining whether a source position of the audio source is within one or more target regions.

13. The device of claim 12, wherein the one or more target regions are based on at least one of a gaze direction of a user, a source localization angle, or a source output.

14. The device of claim 1, wherein the one or more processors are configured to update the priorities based on a change in a source position, a change in a gaze direction of a user, a change in a source localization angle, a change in a source output, or a combination thereof.

15. The device of claim 14, wherein the one or more processors are configured to estimate the change in the gaze direction based on detecting a head rotation of the user.

16. The device of claim 14, wherein the one or more processors are configured to determine the change in the source position based on detecting a movement of an audio source.

17. The device of claim 1, wherein the one or more processors are configured to mix the first audio signal and the second audio signal to generate an output audio signal.

18. The device of claim 1, wherein the one or more processors are configured to:
apply a first gain to the first audio signal to generate a first gain adjusted signal;
apply a second gain to the second audio signal to generate a second gain adjusted signal, wherein the first gain is higher than the second gain; and
mix the first gain adjusted signal and the second gain adjusted signal to generate an output audio signal.

19. The device of claim 1, wherein the one or more processors are configured to, based on determining that a multi-render criterion is satisfied, use multiple renderers including the object renderer and the first ambisonics renderer.

20. The device of claim 19, wherein the one or more processors are configured to determine that the multi-render criterion is satisfied based on determining that a count of the audio sources is greater than a count threshold, that available memory is less than a memory threshold, that remaining battery charge is less than a battery threshold, that a user setting indicates that multiple renderers are to be used, that at least two of the audio sources have source positions in different target regions, or a combination thereof.

21. The device of claim 19, wherein the one or more processors are configured to, based on determining that the multi-render criterion is not satisfied, transition from using the multiple renderers to using a single renderer to generate an output audio signal.

22. The device of claim 1, wherein the first audio source is live, and wherein the second audio source is virtual.

23. The device of claim 1, further comprising one or more microphones, wherein the one or more processors are configured to receive the first audio data from the one or more microphones.

24. The device of claim 1, wherein the one or more processors are further configured to apply audio source extraction to audio data to generate the first audio data and the second audio data.

25. A method comprising:
determining priorities of audio sources of an audio scene;
rendering, using an object renderer, first audio data to generate a first audio signal, the first audio data representing a first audio source associated with a first priority; and
rendering, using an ambisonics renderer, second audio data to generate a second audio signal, the second audio data representing a second audio source associated with a second priority.

26. The method of claim 25, wherein a priority is assigned to an audio source based at least in part on a source position of the audio source in a visual scene.

27. The method of claim 25, wherein the first priority is assigned to the first audio source based at least in part on determining that the first audio source has a first source position within a central target region of a visual scene, and wherein the second priority is assigned to the second audio source based at least in part on determining that the second audio source has a second source position within a peripheral target region of the visual scene.

28. The method of claim 25, wherein target regions have corresponding region priorities, and wherein an audio source is assigned a priority based on a region priority of a particular target region based at least in part on determining that a source position of the audio source is within the particular target region.

29. The method of claim 28, wherein the target regions are based on at least one of a gaze direction of a user, a source localization angle, a source output, a user input, or a configuration setting.

30. The method of claim 25, further comprising updating the priorities based on a change in a source position, a change in a gaze direction of a user, a change in a source localization angle, a change in a source output, a user input, a configuration setting, or a combination thereof.

31. A non-transitory computer readable medium storing instructions that, when executed by one or more processors, cause the one or more processors to:
determine priorities of audio sources of an audio scene;
render, using an object renderer, first audio data to generate a first audio signal, the first audio data representing a first audio source associated with a first priority; and
render, using an ambisonics renderer, second audio data to generate a second audio signal, the second audio data representing a second audio source associated with a second priority.

32. The non-transitory computer readable medium of claim 31, wherein the instructions, when executed by the one or more processors, cause the one or more processors to mix the first audio signal and the second audio signal to generate an output audio signal.

33. An apparatus comprising:
means for determining priorities of audio sources of an audio scene;
means for rendering, using an object renderer, first audio data to generate a first audio signal, the first audio data representing a first audio source associated with a first priority; and
means for rendering, using an ambisonics renderer, second audio data to generate a second audio signal, the second audio data representing a second audio source associated with a second priority.

34. The apparatus of claim 33, wherein the means for determining priorities, the means for rendering first audio data, and the means for rendering second audio data are integrated into at least one of a communication device, a mobile device, a computer, a display device, a television, a gaming console, a music player, a vehicle, a headset, an augmented reality headset, a mixed reality headset, a virtual reality headset, ear phones, an aerial vehicle, a home automation system, a voice-activated device, a wireless speaker and voice activated device, or an internet-of-things (IoT) device.

35. A device comprising:
a memory configured to store first audio data and second audio data; and
one or more processors coupled to the memory and configured to:
determine priorities of audio sources of an audio scene, wherein a first priority is assigned to a first audio source based at least in part on a determination that the first audio source has a first source position within a first target region of a visual scene, and wherein a second priority is assigned to a second audio source based at least in part on a determination that the second audio source has a second source position within a second target region of the visual scene;
render, using a first renderer, the first audio data to generate a first audio signal, wherein the first audio data represents the first audio source associated with the first priority, and wherein the first renderer is of a first renderer type; and
render, using a second renderer, the second audio data to generate a second audio signal, wherein the second audio data represents the second audio source associated with the second priority, and wherein the second renderer is of a second renderer type.

36. The device of claim 35, wherein the first renderer includes an object renderer and the second renderer includes an ambisonics renderer.

37. The device of claim 35, wherein the first renderer includes a higher order ambisonics renderer than an ambisonics renderer included in the second renderer.
